(19) United States
(12) Patent Application Publication
(10) Pub. No.: US 2025/0199535 A1
(43) Pub. Date: Jun. 19, 2025

(54) ROBOT LOCALIZATION USING DATA WITH VARIABLE DATA TYPES

(71) Applicant: Boston Dynamics, Inc., Waltham, MA (US)

(72) Inventors: Joel Elliott Chestnutt, Sudbury, MA (US); Matthew Jacob Klingensmith, Somerville, MA (US); Nicholas Otero, Medford, MA (US); Samuel Frank Seifert, Watertown, MA (US); Christopher Stathis, Watertown, MA (US)

(21) Appl. No.: 18/979,094

(22) Filed: Dec. 12, 2024

Related U.S. Application Data
(60) Provisional application No. 63/610,937, filed on Dec. 15, 2023.

(51) Int. Cl. G05D 1/246; B62D 57/032; G01S 19/45; G05D 1/222; G05D 1/648; G05D 111/50

(52) U.S. Cl. CPC G05D 1/246; B62D 57/032; G01S 19/45; G05D 1/222; G05D 1/648; G05D 2111/54

(57) ABSTRACT

Systems and methods are described for instructing performance of a localization and an action by a mobile robot based on composite data. A system may obtain satellite-based position data and one or more of odometry data or point cloud data. The system may generate composite data by merging the satellite-based position data and the one or more of the odometry data or the point cloud data. The system may instruct performance of a localization by the mobile robot based on the composite data. Based on the localization by the mobile robot, the system may identify an action and instruct performance of the action by a mobile robot.

### CROSS REFERENCE TO RELATED APPLICATION

This U.S. patent application claims priority under 35 U.S.C. § 119 (e) to U.S. Provisional Application No. 63/610,937, filed Dec. 15, 2023, which is considered part of the disclosure of this application and is hereby incorporated by reference in its entirety.

### TECHNICAL FIELD

This disclosure relates generally to robotics, and more specifically, to systems, methods, and apparatuses, including computer programs, for performing localization by a mobile robot.

### BACKGROUND

Robotic devices can autonomously or semi-autonomously navigate sites (e.g., environments) to perform a variety of tasks or functions. The robotic devices can utilize sensor data to navigate the sites without contacting obstacles or becoming stuck or trapped. As robotic devices become more prevalent, there is a need to enable the robotic devices to localize within a site in a more efficient and accurate manner. For example, there is a need to enable the robotic devices to localize within different sites as the robotic devices navigate the sites.

### SUMMARY

An aspect of the present disclosure provides a method that may include obtaining, by data processing hardware of a legged robot, satellite-based position data representing a set of positions of the legged robot within a site of the legged robot. The method may further include generating, by the data processing hardware, composite data reflecting the satellite-based position data and at least one of odometry data or point cloud data. Generating the composite data may include associating each of the set of positions of the legged robot with at least one of a portion of the odometry data or a portion of the point cloud data. The method may further include instructing, by the data processing hardware, the legged robot to perform a localization based on the composite data. The method may further include instructing, by the data processing hardware, the legged robot to perform an action based on the localization.

In various embodiments, generating the composite data may include merging the satellite-based position data and the at least one of the odometry data or the point cloud data.

In various embodiments, the composite data may reflect the satellite-based position data, the odometry data, and the point cloud data.

In various embodiments, the method may further include determining one or more values associated with the point cloud data are less than or equal to one or more reliability thresholds. The composite data may reflect the satellite-based position data and the odometry data. Generating the composite data may be based on determining the one or more values are less than or equal to the one or more reliability thresholds.

In various embodiments, the satellite-based position data may include global positioning system (GPS) data.

In various embodiments, the satellite-based position data may include raw global positioning system coordinates.

In various embodiments, the satellite-based position data may include one or more longitudes and one or more latitudes.

In various embodiments, obtaining the satellite-based position data may include obtaining the satellite-based position data from at least one satellite-based position sensor.

In various embodiments, obtaining the satellite-based position data may include obtaining the satellite-based position data from at least one satellite-based position sensor. The at least one satellite-based position sensor may be detachable from the legged robot.

In various embodiments, obtaining the satellite-based position data may include obtaining the satellite-based position data from at least one satellite-based position sensor. The at least one satellite-based position sensor may be connected to the legged robot via a port.

In various embodiments, the odometry data may be based on one or more steps of one or more legs of the legged robot.

In various embodiments, the method may further include filtering at least a portion of the satellite-based position data from the composite data based on the odometry data.

In various embodiments, the method may further include filtering at least a portion of the satellite-based position data from the composite data based on a number of satellites associated with the satellite-based position data.

In various embodiments, the method may further include filtering at least a portion of the satellite-based position data from the composite data based on an uncertainty associated with the satellite-based position data.

In various embodiments, the method may further include identifying a map. The map may include one or more waypoints and one or more edges. Instructing the legged robot to perform the localization may further be based on the map.

In various embodiments, the satellite-based position data may include first satellite-based position data. The method may further include identifying a map. The map may include one or more waypoints and one or more edges. The one or more waypoints may be associated with second satellite-based position data. Instructing the legged robot to perform the localization may further be based on the map.

In various embodiments, the satellite-based position data may include first satellite-based position data. The method may further include identifying a map. The map may include one or more waypoints and one or more edges. The one or more waypoints may be associated with second satellite-based position data. Instructing the legged robot to perform the localization may further be based on the map. The map may be generated prior to the legged robot traversing the site.

In various embodiments, the satellite-based position data may include first satellite-based position data. The method may further include identifying a map that may include one or more waypoints and one or more edges. The one or more waypoints may be associated with the composite data. Instructing the legged robot to perform the localization may further be based on second satellite-based position data.

In various embodiments, the composite data may further include at least one of ground plane data, step location data, fiducial data, loop closure data, or a user annotation. The method may further include identifying a map that may include one or more waypoints and one or more edges. The one or more waypoints may be associated with the composite data. Instructing the legged robot to perform the localization may further be based on the map.

In various embodiments, the method may further include identifying a map that may include one or more waypoints and one or more edges. The one or more waypoints may be associated with the composite data. Instructing the legged robot to perform the localization may further be based on the map. The method may further include identifying a relationship between a first waypoint of the one or more waypoints and a second waypoint of the one or more waypoints based on the composite data.

In various embodiments, the method may further include identifying a map that may include one or more waypoints and one or more edges. The one or more waypoints may be associated with the composite data. Instructing the legged robot to perform the localization may further be based on the map. The method may further include identifying a relationship between the one or more waypoints and the site based on the composite data.

In various embodiments, the method may further include identifying a map that may include one or more waypoints and one or more edges. The one or more waypoints may be associated with composite data. Instructing the legged robot to perform the localization may further be based on the map. The method may further include identifying a first relationship between a first waypoint of the one or more waypoints and a second waypoint of the one or more waypoints based on the composite data using an optimization problem. The method may further include identifying a second relationship between the one or more waypoints and the site based on the composite data using the optimization problem.

In various embodiments, the method may further include identifying a map that may include one or more waypoints and one or more edges. The one or more waypoints may be associated with the composite data. Instructing the legged robot to perform the localization may further be based on the map. The method may further include identifying a first relationship between a first waypoint of the one or more waypoints and a second waypoint of the one or more waypoints based on the composite data using an optimization problem. The method may further include identifying a second relationship between the one or more waypoints and the site based on the composite data using the optimization problem. One or more variables of the optimization problem may include one or more locations of the one or more waypoints.

In various embodiments, the composite data may further include at least one of ground plane data, step location data, fiducial data, loop closure data, or a user annotation. The method may further include identifying a map that may include one or more waypoints and one or more edges. The one or more waypoints may be associated with the composite data. Instructing the legged robot to perform the localization may further be based on the map. The method may further include identifying a first relationship between a first waypoint of the one or more waypoints and a second waypoint of the one or more waypoints using an optimization problem. The method may further include identifying a second relationship between the one or more waypoints and the site using the optimization problem. One or more variables of the optimization problem may further include one or more locations of the one or more waypoints. One or more cost functions of the optimization problem may be based on one or more of the satellite-based position data, the odometry data, the point cloud data, the ground plane data, the step location data, the fiducial data, the loop closure data, or the user annotation.

In various embodiments, the method may further include generating a user interface. The user interface may include the composite data overlaid on a representation of the site.

In various embodiments, the method may further include generating a user interface. The user interface may include the composite data overlaid on a representation of a satellite view of the site.

In various embodiments, the method may further include generating a user interface. The user interface may include the composite data overlaid on a representation of the site. The method may further include instructing display of the user interface.

In various embodiments, the method may further include generating a user interface. The user interface may include the composite data overlaid on a representation of the site. The method may further include instructing display of the user interface. The method may further include receiving input via the user interface. The method may further include instructing the legged robot to navigate to a waypoint based on the input.

In various embodiments, the method may further include generating a user interface. The user interface may include the composite data overlaid on a representation of the site. The method may further include instructing display of the user interface. The method may further include receiving input via the user interface. The method may further include instructing the legged robot to navigate to a location within the site based on the input.

In various embodiments, the method may further include generating a user interface. The user interface may include the composite data overlaid on a representation of the site. The method may further include instructing display of the user interface. The method may further include receiving input via the user interface. The method may further include updating the composite data based on the input.

In various embodiments, the method may further include generating a user interface. The user interface may include the composite data overlaid on a representation of the site. The method may further include instructing display of the user interface. The method may further include receiving input via the user interface. The method may further include updating the satellite-based position data based on the input.

In various embodiments, the method may further include generating a user interface. The user interface may include the composite data overlaid on a representation of the site. The method may further include updating the user interface in real time to provide a live representation of a position of the legged robot within the site.

In various embodiments, the method may further include obtaining, from a user computing device, data identifying a waypoint. Instructing the legged robot to perform the localization may further be based on the waypoint.

In various embodiments, the method may further include automatically performing loop closure generation based on the satellite-based position data.

In various embodiments, the method may further include identifying a relationship between at least one of the site or at least a portion of the composite data and a physical coordinate system. The method may further include generating a user interface. The user interface may indicate the relationship. The method may further include instructing display of the user interface.

According to various embodiments of the present disclosure, a system may include data processing hardware and memory in communication with the data processing hardware. The memory may store instructions that when executed on the data processing hardware cause the data processing hardware to obtain satellite-based position data representing a set of positions of a legged robot within a site of the legged robot. Execution of the instruction may further cause the data processing hardware to generate composite data reflecting the satellite-based position data and at least one of odometry data or point cloud data. Generating the composite data may include associating each of the set of positions of the legged robot with at least one of a portion of the odometry data or a portion of the point cloud data. Execution of the instruction may further cause the data processing hardware to instruct the legged robot to perform a localization based on the composite data. Execution of the instruction may further cause the data processing hardware to instruct the legged robot to perform an action based on the localization. The system may include any combination of the above features.

According to various embodiments of the present disclosure, a robot may include at least two legs, data processing hardware, and memory in communication with the data processing hardware. The memory may store instructions that when executed on the data processing hardware cause the data processing hardware to obtain satellite-based position data representing a set of positions of the robot within a site of the robot. Execution of the instruction may further cause the data processing hardware to generate composite data reflecting the satellite-based position data and at least one of odometry data or point cloud data. Generating the composite data may include associating each of the set of positions of the robot with at least one of a portion of the odometry data or a portion of the point cloud data. Execution of the instruction may further cause the data processing hardware to instruct the robot to perform a localization based on the composite data. Execution of the instruction may further cause the data processing hardware to instruct the robot to perform an action based on the localization. The robot may include any combination of the above features.

According to various embodiments of the present disclosure, a method may include obtaining, by data processing hardware of a legged robot, localization data associated with the legged robot. The localization data may include satellite-based position data and at least one of odometry data or point cloud data. The method may further include filtering, by the data processing hardware, the localization data to remove one of the satellite-based position data, the odometry data, or the point cloud data based on one or more reliability thresholds to obtain filtered localization data. The method may further include instructing, by the data processing hardware, the legged robot to perform a localization based on the filtered localization data. The method may further include instructing, by the data processing hardware, the legged robot to perform an action based on the localization.

According to various embodiments of the present disclosure, a method may include obtaining, by data processing hardware of a legged robot, sensor data associated with the legged robot. The method may further include determining, by the data processing hardware, that the sensor data has a data type corresponding to a satellite-based position data type or a combination of the satellite-based position data type and an odometry data type. The method may further include determining, by the data processing hardware, a manner of performing localization based on the data type. Data having the satellite-based position data type may be associated with a first manner of performing localization. Data having the odometry data type may be associated with a second manner of performing localization. Data having a combination of the satellite-based position data type and the odometry data type may be associated with a third manner of performing localization. The method may further include instructing, by the data processing hardware, the legged robot to perform a localization based on the sensor data and the manner of performing localization. The method may further include instructing, by the data processing hardware, the legged robot to perform an action based on the localization.

According to various embodiments of the present disclosure, a method may include obtaining, by data processing hardware of a legged robot, a first set of satellite-based position data associated with the legged robot. The method may further include instructing, by the data processing hardware, the legged robot to perform a first localization based on the first set of satellite-based position data using a second set of satellite-based position data associated with a first waypoint. The method may further include instructing, by the data processing hardware, the legged robot to perform a first action based on the first localization. The method may further include obtaining, by the data processing hardware, a first set of odometry data associated with the legged robot. The method may further include instructing, by the data processing hardware, the legged robot to perform a second localization based on the first set of odometry data using a second set of odometry data associated with the first waypoint. The method may further include instructing, by the data processing hardware, the legged robot to perform a second action based on the second localization.

According to various embodiments of the present disclosure, a method may include obtaining, by data processing hardware of a legged robot, satellite-based position data representing a set of positions of the legged robot within a site of the legged robot. The method may further include obtaining, by the data processing hardware, satellite-based image data representing an image of the site. The method may further include identifying, by the data processing hardware, a representation of a satellite view of the site based on the satellite-based image data. The method may further include generating, by the data processing hardware, a user interface. The user interface may include the satellite-based position data overlaid on the representation of the satellite view of the site. The method may further include instructing, by the data processing hardware, display of the user interface.

In various embodiments, the satellite-based image data may include a satellite tile.

In various embodiments, instructing display of the user interface may include instructing display of the user interface via a user computing device.

In various embodiments, instructing display of the user interface may include instructing display of the user interface via a user computing device. The method may further include instructing, by the data processing hardware, movement of the legged robot based on input received via the user computing device.

In various embodiments, the user interface may further include point cloud data overlaid on the representation of the satellite view of the site.

In various embodiments, the user interface may indicate one or more obstacles in the site with respect to the representation of the satellite view of the site.

In various embodiments, the user interface may indicate one or more objects in the site with respect to the representation of the satellite view of the site.

In various embodiments, the user interface may indicate a terrain of the site with respect to the representation of the satellite view of the site.

In various embodiments, the user interface may indicate one or more waypoints with respect to the representation of the satellite view of the site.

In various embodiments, the user interface may indicate one or more edges with respect to the representation of the satellite view of the site.

In various embodiments, obtaining the satellite-based position data may include obtaining the satellite-based position data in real time.

In various embodiments, the method may further include updating the user interface.

In various embodiments, the method may further include updating the user interface in real time.

In various embodiments, the method may further include updating the user interface to obtain an updated user interface.

In various embodiments, the method may further include updating the user interface to obtain an updated user interface. The method may further include instructing display of the updated user interface.

According to various embodiments of the present disclosure, a method may include obtaining, by first data processing hardware of a first legged robot located within a site, from one or more first sensors associated with the first legged robot, a first set of sensor data associated with the first legged robot. The first set of sensor data may include satellite-based position data. The method may further include instructing, by the first data processing hardware, the first legged robot to localize within the site based on the first set of sensor data. The method may further include obtaining, by second data processing hardware of a second legged robot located within the site, from one or more second sensors associated with the second legged robot, a second set of sensor data associated with the second legged robot. The one or more first sensors and the one or more second sensors may include different sensors. The first set of sensor data and the second set of sensor data may have different data types. The method may further include instructing, by the second data processing hardware, the second legged robot to localize within the site based on the second set of sensor data.

According to various embodiments of the present disclosure, a method may include obtaining, by data processing hardware of a legged robot, a first set of localization data associated with the legged robot. The legged robot may include one or more ports. The method may further include instructing, by the data processing hardware, the legged robot to perform a first localization based on the first set of localization data. The method may further include instructing, by the data processing hardware, the legged robot to perform a first action based on the first localization. The method may further include determining, by the data processing hardware, a connection of satellite-based position sensor to a port of the one or more ports. The method may further include obtaining, by the data processing hardware, a second set of localization data associated with the legged robot. The second set of localization data may include satellite-based position data based on the connection of the satellite-based position sensor to the port. The method may further include instructing, by the data processing hardware, the legged robot to perform a second localization based on the second set of localization data. The method may further include instructing, by the data processing hardware, the legged robot to perform a second action based on the second localization.

According to various embodiments of the present disclosure, a robot may include at least two legs, data processing hardware, and memory in communication with the data processing hardware. The memory may store instructions that when executed on the data processing hardware cause the data processing hardware to perform any combination of the above features.

According to various embodiments of the present disclosure, a system may include data processing hardware and memory in communication with the data processing hardware. The memory may store instructions that when executed on the data processing hardware cause the data processing hardware to perform any combination of the above features.

The details of the one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example robot for navigating a site.

FIG. 2 is a schematic view of example systems for the robot of FIG. 1.

FIG. 3A is a schematic view of a sensor system in communication with example systems of a robot.

FIG. 3B is a schematic view of various systems of a robot.

FIG. 4 is a schematic view of a site.

FIG. 5A is a schematic view of a site including a representation of odometry data associated with a robot.

FIG. 5B is a schematic view of a site including a representation of point cloud data associated with a robot.

FIG. 5C is a schematic view of a site including a representation of satellite-based position data associated with a robot.

FIG. 6A is a schematic view of a robot using composite data to localize within a site.

FIG. 6B is a schematic view of a robot using composite data to localize within a site.

FIG. 6C is a schematic view of a robot using composite data to localize within a site.

FIG. 7A is a schematic view of an example user interface including composite data overlaid on a representation of a site.

FIG. 7B is a schematic view of an example user interface including composite data overlaid on a representation of a site.

FIG. 7C is a schematic view of an example user interface including a representation of a robot overlaid on a representation of a site.

FIG. 7D is a schematic view of an example user interface including composite data overlaid on a representation of a site.

FIG. 8 is a flowchart of an example arrangement of operations for instructing performance of a localization and performance of an action by a mobile robot.

FIG. 9 is a schematic view of an example computing device that may be used to implement the systems and methods described herein.

Like reference symbols in the various drawings indicate like elements.

### DETAILED DESCRIPTION

Generally described, autonomous and semi-autonomous robots can utilize mapping, localization, and navigation systems to map a site utilizing sensor data obtained by the robots. The robots can obtain data associated with the robot from one or more components of the robots (e.g., sensors, sources, outputs, etc.). For example, the robots can receive sensor data from an image sensor, a lidar sensor, a ladar sensor, a radar sensor, pressure sensor, an accelerometer, a battery sensor (e.g., a voltage or current meter), a speed sensor, a position sensor, an orientation sensor, a pose sensor (e.g., a sensor that estimates a pose of the robot, an entity within a site, etc. based on image data, position data, orientation data, etc.), a tilt sensor, and/or any other component of the robot. Further, the sensor data may include image data, lidar data, ladar data, radar data, pressure data, acceleration data, battery data (e.g., voltage data), speed data, position data, orientation data, pose data, tilt data, etc.

The robots can utilize the mapping, localization, and navigation systems and the sensor data to perform mapping, localization, and/or navigation in the site and build navigation graphs that identify route data (e.g., a series of route waypoints and route edges). The route data may indicate one or more route waypoints (also referred to as waypoints) and one or more route edges (also referred to as edges) connecting the one or more route waypoints for the robots. To traverse a site, the robots may navigate between the one or more route waypoints using the one or more route edges. During the mapping, localization, and/or navigation, the robots may identify an output based on identified features representing entities, objects, obstacles, or structures within the site. For example, the entities may be adult humans, children humans, other robots (e.g., other legged robots), animals, non-robotic machines (e.g., forklifts), etc. within the site.

The present disclosure relates to localization and performance of one or more actions (e.g., a job, a task, an operation, etc.) by a robot using composite data. As discussed above, a robot can include multiple sensors. All or a portion of the multiple sensors can provide sensor data (e.g., having different data types) to a computing system. For example, a first sensor may provide point cloud data to the computing system, a second sensor may provide odometry data, a third sensor may provide satellite-based position data (e.g., Global Navigation Satellite System data), etc. The computing system may generate composite data based on the obtained sensor data (e.g., by merging the sensor data), instruct performance of a localization by the robot based on the composite data, and instruct performance of one or more actions by the robot based on the localization by the robot.

In systems performing single sensor modality localization, while a robot may be programmed to perform a localization within a site, such systems may be limited in the manner in which the robot performs the localization (e.g., what data the robot uses to perform the localization). For example, such systems may be limited to instructing a robot to perform a localization using particular data or a particular type of data (e.g., point cloud data).

As such systems may be limited in the manner in which the robot performs the localization, the robot may be unable to perform localization in particular sites (e.g., outdoor sites, covered sites, underground sites, etc.) based on the conditions or parameters of the site (e.g., objects, obstacles, entities, or structures within the site, location, position with respect to one or more satellites, etc.) which may affect the quality of the data. Some sites may result in lower quality sensor data as compared to other sites such that a robot in such a system may be unable to perform localization accurately in the sites. Such sites may not include a particular number of objects, obstacles, entities, or structures that correspond to features such that the robot is unable to accurately perform localization and determine the location of the robot. For example, the robot may be unable to perform localization in a site that does not correspond to a particular number of features corresponding to entities, objects, obstacles, or structures in the site (e.g., a feature desert), in a site in which the robot is unable to obtain a connection with another computing system (e.g., a satellite), etc. A site may be a feature desert and/or a system may identify a site as (or as corresponding to) a feature desert if the number of features corresponding to the site does not satisfy (e.g., is less than, matches, etc.) a threshold. For example, the system may identify a site as a feature desert if the site corresponds to less than three features. Therefore, the robot may be unable to identify a position within a particular site.

In some cases, a robot may traverse multiple sites or a site that includes a varying number of entities, objects, obstacles, or structures and/or the robot has a varying level of connectivity (e.g., network connectivity, satellite connectivity, etc.) at different portions of the site. For example, the robot may be able to connect with one satellite at a first portion of the site and five satellites at a second portion of the site. Depending on the varying number of entities, objects, obstacles, or structures and/or the varying level of connectivity, in such systems, the robot may be unable to perform localization in a first portion of the site and may be able to perform localization in a second portion of the site. In such systems, as the robot may utilize the same type of data to perform localization across a site or across multiple sites, while the robot may perform localization in particular sites or particular portions of the site, if the robot is unable to obtain sensor data or is unable to obtain sensor data that matches or exceeds a threshold, the robot may be unable to perform localization. As the robot may be unable to perform localization, the robot may become lost or confused.

Such a lack of customization in how the robot performs localization in such systems may cause issues and/or inefficiencies (e.g., computational inefficiencies) as the robot may be unable to localize and accurately navigate in particular sites and/or may require additional input. For example, a robot in such a system may be unable to localize and navigate in a particular site without manual input.

As robots in such systems may not be capable of localizing and navigating in particular sites, such systems may not operate safely and predictably in such sites (e.g., the robot may contact an obstacle, the robot may become stuck, etc.).

In some cases, a user may attempt to manually localize a robot within a particular site. However, such a process may be inefficient and error prone as the user may be unable to identify how to localize a robot within a particular site in a time-efficient manner such that the robot can perform a particular action.

As components (e.g., mobile robots) proliferate, the demand for more accurate and effective localization within a site has increased. Specifically, the demand has increased for a robot to be able to localize effectively and accurately within different sites using variable data (e.g., variable types of data, variable quantities of data, etc.).

The present disclosure provides systems and methods that enable an increase in the effectiveness and accuracy of the localization of the robot using variable data in different sites. Specifically, the methods and apparatuses described herein enable a system to generate composite data from satellite-based position data and one or more of odometry data or point cloud data and use the composite data for localization. For example, the composite data may include satellite-based position data and odometry data, satellite-based position data and point cloud data, or satellite-based position data, odometry data, and point cloud data. By utilizing composite data that includes and/or is based on satellite-based position data, the system can increase the accuracy and efficiency of one or more operations (e.g., localization).

As described herein, the process of generating the composite data and instructing performance of the localization may include obtaining sensor data. For example, the system may obtain sensor data from one or more sensors of the robots (e.g., based on traversal of the site by the robot). In some cases, the system may obtain sensor data without traversing the site by the robot. For example, the system may obtain satellite-based position data without traversing the site.

In some cases, the system may be in communication with (and may receive data from) a set of sensors of the robot. One or more of the sensors may be removably connected (e.g., attached, linked, etc.) to the robot via one or more wired or wireless ports (e.g., a hub, a data connection, etc.). In some cases, one or more different sensors may be removably connected to the robot via a port. For example, an image sensor may be removably connected to the robot via the port (e.g., during a first time period) and a satellite-based position sensor may be removably connected to the robot via the port (e.g., during a second time period). In some cases, one or more of the sensors may be removably connected to the robot and one or more of the sensors may not be removably connected to the robot (e.g., may be integrated within the robot, may be affixed to the robot, etc.).

In some cases, the system may obtain all or a portion of the sensor data via an interface (e.g., an application programming interface). For example, the system may obtain the satellite-based position data via an application programming interface.

As discussed above, the sensor data may include sensor data from multiple sensors. For example, the sensor data may include a first portion of sensor data from a first sensor or first set of sensors (e.g., including one or more lidar sensors) and a second portion of sensor data from a second sensor or second set of sensors (e.g., including one or more satellite-based position sensors).

The system may be in communication with a set of sensors (e.g., a first sensor, a second sensor, etc.) of the robot. The system may obtain sensor data from a first subset of the set of sensors and may not obtain sensor data from a second subset of the set of sensors when the robot is located in a first portion of a site. For example, the system may not obtain point cloud data from a lidar sensor of the robot when the robot is located in a portion of a site that does not include entities, objects, obstacles, or structures for which point cloud data may be obtained. In another example, the system may not obtain satellite-based position data from a satellite-based position sensor of the robot when the robot is located in an enclosed site (e.g., a building, underground, etc.) and the satellite-based position sensor is unable to connect to one or more satellites.

In some cases, the system may filter the sensor data prior to generation of the composite data. The system may process the sensor data, determine one or more portions of the sensor data do not satisfy (e.g., exceed or match) one or more thresholds (e.g., threshold values, threshold ranges, etc.), and filter the one or more portions of the sensor data from the sensor data based on determining the one or more portions of the sensor data do not satisfy the one or more thresholds. For example, to determine the one or more portions of the sensor data that do not satisfy the one or more thresholds (e.g., reliability thresholds), the system may compare the sensor data with the one or more thresholds. Based on filtering the one or more portions of the sensor data from the sensor data (e.g., according to the one or more thresholds), the composite data may not include the one or more portions of the sensor data.

The system may obtain the sensor data from the sensors and generate composite data based on the sensor data. To generate the composite data, the system may merge (e.g., fuse, combine, blend, unite, join, integrate, associate, etc.) the sensor data from the sensors. For example, the system may merge first sensor data from a first sensor with second sensor data from a second sensor and third sensor data from a third sensor to generate composite data.

In some cases, to merge the first portion of sensor data and the second portion of sensor data, the system can align (e.g., temporally, physically with respect to a site, etc.) the first portion of sensor data and the second portion of sensor data within the composite data. For example, the system can temporally align satellite-based position data and point cloud data based on one or more timestamps associated with the satellite-based position data and the point cloud data.

As discussed above, the composite data may include and/or may be based on satellite-based position data. The satellite-based position data and the other data included within the composite data (e.g., point cloud data, odometry data, etc.) and/or the associated sensors may have different attributes (e.g., accuracy, reliability, confidence, quantity, quality, etc.). For example, the attributes may relate to how the associated sensor data can be used to perform one or more operations (e.g., an accuracy in performing localization).

In some cases, the attributes may be location specific (e.g., site specific). For example, a satellite-based position sensor may provide first sensor data with a first accuracy, first reliability, etc. in a first location of a site (e.g., outdoor) and second sensor data with a second accuracy, a second reliability, etc. which is less than the first accuracy, first reliability, etc. in a second location of the site or a different site (e.g., indoor). In another example, a satellite-based position sensor may provide first sensor data with a first accuracy, first reliability, etc. in a first location of a site (e.g., a location corresponding to a first number of features) and second sensor data with a second accuracy, a second reliability, etc. which is less than the first accuracy, first reliability, etc. in a second location of the site or a different site (e.g., a location corresponding to a second number of features that is less than the first number).

In generating composite data that may include the satellite-based position data, the system can utilize composite data that has greater attributes (e.g., greater accuracy) as compared to the individual attributes of the point cloud data, the satellite-based position data, the odometry data, etc. For example, a satellite-based position sensor may provide first sensor data with a first accuracy, first reliability, etc. in a first location of a site (e.g., outdoor) and a lidar sensor may provide second sensor data with a second accuracy, a second reliability, etc. which is less than the first accuracy, first reliability, etc. in the first location and the system may generate composite data based on the first sensor data and the second sensor data, the composite data having a third accuracy, third reliability, etc. which is greater than the first accuracy, first reliability, etc.

By merging sensor data (e.g., odometry data, point cloud data, merged odometry data and point cloud data, etc.) with satellite-based position data (and utilizing composite data that includes and/or may be based on satellite-based position data), the system can increase the accuracy and efficiency of one or more operations (e.g., localization) and/or account for issues (e.g., uncertainty, lack of data, etc.) associated with the odometry data, the point cloud data, etc. For example, point cloud data and/or odometry data may be associated with a particular attribute (e.g., level of uncertainty) such that a system performing localization using the point cloud data and/or the odometry data may perform localization with a first accuracy that is below a threshold and, by merging the point cloud data and/or odometry data with satellite-based position data, the system can perform localization with a second accuracy that is greater than the first accuracy.

Further, the system may determine that a robot is lost (e.g., unable to localize) based on odometry data and/or the point cloud data (e.g., based on a site not corresponding to a particular number of features). For example, the system may determine that the robot is lost based on the system not obtaining odometry data and/or the point cloud data. By merging the odometry data and/or point cloud data with the satellite-based position data, the system can verify (and more accurately identify) whether the robot is lost using the composite data that includes the satellite-based position data. In some cases, while the system may determine that the robot is lost based on the odometry data and/or the point cloud data (or lack thereof), based on the addition of satellite-based position data, the system may determine that the robot is not lost.

In some cases, the system may merge the first portion of sensor data and the second portion of sensor data by integrating data from the first portion of sensor data and the second portion of sensor data and eliminating duplicative and/or inconsistent data. For example, the system may remove data that corresponds to a particular background object (e.g., representing a wall).

In some cases, the system may filter the composite data. The system may process the composite data, determine that one or more portions of the composite data do not satisfy (e.g., exceed or match) one or more thresholds, and filter the one or more portions of the composite data from the composite data.

By merging satellite-based position data with odometry data and/or point cloud data, the system can utilize the satellite-based position data to filter the odometry data and/or the point cloud data and/or can utilize the odometry data and/or the point cloud data to filter the point cloud data. For example, the system can verify whether odometry data and/or point cloud data that is temporally aligned with satellite-based position data within the composite data indicates a same location. If the system determines that one or more of the odometry data, the point cloud data, and/or the satellite-based position data indicates a different location, the system can filter one or more of the odometry data, the point cloud data, and/or the satellite-based position data from the composite data. In some cases, the system can identify the satellite-based position data as the source of truth and may filter the odometry data and/or the point cloud data from the composite data if the system determines that one or more of the odometry data, the point cloud data, and/or the satellite-based position data indicates a different location.

The system may generate a map (e.g., a localization map) to enable localization of the robot based on the composite data. The map may include a route of the robot through the site. The route may include a set of route waypoints and a set of route edges connecting the set of route waypoints. The system may associate all or a portion of the set of route waypoints with respective composite data. For example, the robot may navigate through a site and obtain composite data at a set of route waypoints and the system may generate a map that links all or a portion of the set of route waypoints to respective composite data (e.g., composite data captured by the robot or a different robot at the particular route waypoint) based on navigation of the robot. In some cases, the system may use the composite data to perform loop closure (e.g., automatically) and generate the map based on the performed loop closure.

In some cases, as the system can obtain sensor data (e.g., satellite-based position data) without traversal of the site, the system may generate the map to enable localization of the robot within the site without traversal of the site by the robot. For example, the system may associate all or a portion of the route waypoints within the map with respective satellite-based position data to enable localization of the robot within the site.

Based on generation of the map, the system may instruct localization of the robot according to the map. The system may instruct the robot to perform a localization based on the map and additional composite data. For example, the system may obtain first composite data (as discussed above) and may instruct the robot to localize within the site based on the first composite data and second composite data that is associated with the map (e.g., linked to one or more route waypoints within the map). The system may instruct the robot to perform a localization to determine a position (e.g., a local position, an actual position, etc.) associated with a site (e.g., with respect to the site, in the site, etc.). In some cases, the system may instruct the robot to continuously (or at certain discrete intervals, e.g., at a fixed periodicity) perform a localization to determine a position of the robot within the site.

In some cases, the system may instruct performance of an action by the robot (e.g., instructing the robot to move one or more legs or an arm of the robot, instructing the robot to obtain sensor data from one or more sensors, instructing the robot to provide an audio or visual output, instructing manipulation of an entity, object, obstacle, or structure within the site, etc.) based on the localization of the robot. For example, the system may instruct performance of a localization by the robot such that the robot identifies a position of the robot within a site (e.g., in front of a lever) and, based on the position of the robot, the system may instruct performance of one or more actions by the robot (e.g., pull the lever).

The system may instruct display of the composite data via a user interface of a computing device (e.g., a user computing device). For example, the system may instruct display of the composite data (e.g., a representation of the composite data) and/or a map based on the composite data overlaid on a representation of the site (e.g., a site model, a satellite view of the site, etc.). In another example, the system may instruct a live representation (e.g., a continuously updated representation) of the robot with respect to the site (e.g., a satellite view of the site) to enable live monitoring of the robot with respect to the site by a user. In some cases, the system may instruct display of the composite data and/or the map embedded within a satellite view such that the composite data and/or the map are displayed with respect to streets, buildings, landmarks, etc.

In some cases, the system may receive input via the user interface. For example, the input may define one or more edits to the composite data (e.g., the satellite-based position data), the map (e.g., a location of one or more route waypoints), etc., one or more commands (e.g., navigate to a particular route waypoint or location), etc. with respect to the site (e.g., the satellite view of the site). Based on the input, the system may adjust the composite data, the map, etc.

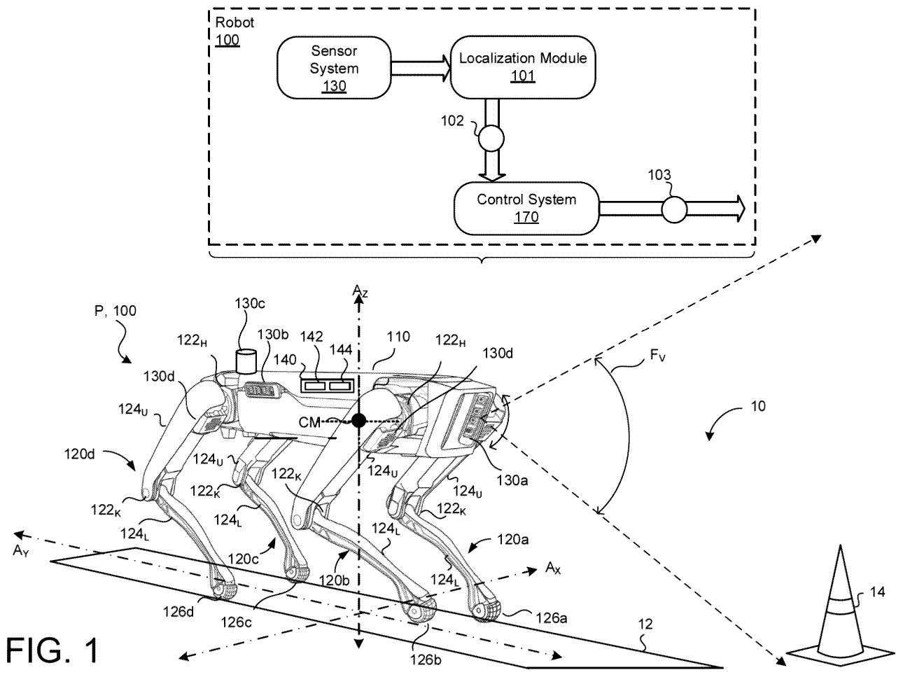

FIG. 1 is a schematic view of a robot 100 for navigating a site 10. The robot 100 may include a body 110 with locomotion-based structures such as legs 120a, 120b, 120c, and 120d coupled to the body 110 that enable the robot 100 to move about a site 10. In some examples, all or a portion of the legs 120a, 120b, 120c, and 120d may be an articulable structure such that one or more joints permit members of the legs 120a, 120b, 120c, and 120d to move. For example, all or a portion of the legs 120a, 120b, 120c, and 120d may respectively include a hip joint 122_{H} coupling an upper member 124_{U} of the leg to the body 110 and a knee joint 122_{K} coupling the upper member 124_{U} to a lower member 124_{L} of the leg. Although FIG. 1 depicts a quadruped robot with four legs, the robot 100 may include any number of legs or locomotive based structures (e.g., a biped or humanoid robot with two legs) that provide a means to traverse the terrain within the site 10.

In some cases, the robot 100 may include one or more arms. For example, the robot 100 may include an arm affixed to a top portion (relative to a ground surface) of the body 110 of the robot 100. The arm may include one or more articulable sections and/or a hand member to perform one or more actions (e.g., turn a dial, pull a lever, open a door, etc.).

In order to traverse the terrain, the legs 120a, 120b, 120c, and 120d may have distal ends 126a, 126b, 126c, and 126d (e.g., feet of the robot 100) that contact a surface of the terrain (i.e., a traction surface). The distal ends 126a, 126b, 126c, and 126d of the legs 120a, 120b, 120c, and 120d are ends of the legs 120a, 120b, 120c, and 120d used by the robot 100 to pivot, plant, or generally provide traction during movement of the robot 100. For example, the distal ends 126a, 126b, 126c, and 126d of the legs 120a, 120b, 120c, and 120d correspond to feet of the robot 100. In some examples, although not shown in FIG. 1, all or a portion of the distal ends 126a, 126b, 126c, and 126d may include a respective ankle joint such that the distal ends 126a, 126b, 126c, and 126d may be articulable with respect to the lower member 124_{L} of the respective leg.

The robot 100 may have a vertical gravitational axis (e.g., shown as a Z-direction axis A_{Z}) along a direction of gravity, and a center of mass CM, which may be a point where the weighted relative position of the distributed mass of the robot 100 sums to zero. The robot 100 further may have a pose P based on the center of mass CM relative to the vertical gravitational axis A_{Z} (the fixed reference frame with respect to gravity) to define a particular attitude or stance assumed by the robot 100. The attitude of the robot 100 can be defined by an orientation or an angular position of the robot 100 in space. Movement by the legs 120a, 120b, 120c, and 120d relative to the body 110 alters the pose P of the robot 100 (e.g., the combination of the position of the CM of the robot and the attitude or orientation of the robot 100).

A height may refer to a distance along the z-direction. A ground plane (e.g., a transverse plane) may span the X-Y plane by extending in directions of the x-direction axis A_{X} and the y-direction axis A_{Y}. The ground plane may refer to a ground surface 12 where the distal ends 126a, 126b, 126c, and 126d may generate traction to help the robot 100 move about the site 10. Another anatomical plane of the robot 100 may be the frontal plane that extends across the body 110 of the robot 100 (e.g., from a left side of the robot 100 with leg 120a (e.g., a first leg) to a right side of the robot 100 with leg 120b (e.g., a second leg). The frontal plane may span the X-Z plane by extending in directions of the x-direction axis A_{X} and the z-direction axis A_{Z}.

When the robot 100 moves about the site 10, the legs 120a, 120b, 120c, and 120d may undergo a gait cycle. A gait cycle may begin when a leg of the legs 120a, 120b, 120c, and 120d touches down or contacts the ground surface 12 and ends when the leg once again contacts the ground surface 12. The gait cycle may be divided into two phases, a swing phase and a stance phase.

During the swing phase, a leg may perform (i) lift-off from the ground surface 12 (also sometimes referred to as toe-off and the transition between the stance phase and swing phase), (ii) flexion at a knee joint 122_{K} of the leg, (iii) extension of the knee joint 122_{K} of the leg, and (iv) touchdown back to the ground surface 12. A leg in the swing phase may be referred to as a swing leg.

As the swing leg proceeds through the movement of the swing phase, one or more other legs of the legs 120a, 120b, 120c, and 120d may perform the stance phase. The stance phase may refer to a period of time where a distal end of the leg is on the ground surface 12. During the stance phase, a leg may perform (i) initial ground surface contact which triggers a transition from the swing phase to the stance phase, (ii) loading response where the leg dampens ground surface contact, (iii) mid-stance support for when the contralateral leg (e.g., the swing leg) lifts-off and swings to a balanced position (about halfway through the swing phase), and (iv) terminal-stance support from when the robot's center of mass CM is over the leg until the contralateral leg touches down to the ground surface 12. A leg in the stance phase may be referred to as a stance leg.

In order to maneuver about the site 10, the robot 100 may include a sensor system 130, a localization module 101, and/or a control system 170. As discussed below, the robot 100 may include more, less, or different systems. In some cases, all or a portion of the sensor system 130 may be remote and/or distinct from the robot 100. In some cases, all or a portion of the sensor system 130 may be connected to the robot 100 via a port such that all or a portion of the sensor system 130 is removable (e.g., detachable) from the robot 100. Further, all or a portion of the sensor system 130 may be integrated within the robot 100 (e.g., built into the robot 100).

The sensor system 130 may include one or more first sensors 130a located on a front portion of the robot 100 (e.g., a face of the robot 100), one or more second sensors 130b located on all or a portion of the sides of the body 110 of the robot 100, one or more third sensors 130c located on top of the body 110 of the robot, and one or more fourth sensors 130d located on all or a portion of the legs 120a, 120b, 120c, and 120d.

The one or more first sensors 130a, the one or more second sensors 130b, the one or more third sensors 130c, and the one or more fourth sensors 130d may include one or more vision/image sensors, inertial sensors (e.g., an inertial measurement unit (IMU)), force sensors, satellite-based position sensors, position sensors, and/or kinematic sensors. Some examples of image sensors may include a camera such as a stereo camera, a scanning light-detection and ranging (LIDAR) sensor, or a scanning laser-detection and ranging (LADAR) sensor.

All or a portion of the one or more first sensors 130a, the one or more second sensors 130b, the one or more third sensors 130c, and the one or more fourth sensors 130d may have a corresponding field(s) of view Fᵥ defining a sensing range or region corresponding to the respective sensor. FIG. 1 depicts a field of a view F_{V} for the robot 100. All or a portion of the one or more first sensors 130a, the one or more second sensors 130b, the one or more third sensors 130c, and the one or more fourth sensors 130d may be pivotable and/or rotatable such that the respective sensor may, for example, change the field of view F_{V} about one or more axis (e.g., an x-axis, a y-axis, or a z-axis in relation to a ground plane).

In some cases, the one or more fourth sensors 130d may include position sensor(s) coupled to a hip joint 122_{H} and/or a knee joint 122_{K}. In some examples, the position sensors may couple to a motor that operates a hip joint 122_{H} and/or a knee joint 122_{K} of the robot 100. The position sensors may generate joint dynamics in the form of joint-based sensor data. Joint dynamics collected as joint-based sensor data may include joint angles (e.g., an angle of an upper member 124_{U} relative to a lower member 124_{L}), joint speed (e.g., joint angular velocity or joint angular acceleration), and/or joint torques experienced at a hip joint 122_{H} and/or a knee joint 122_{K} (e.g., joint forces). Joint-based sensor data generated by one or more sensors may be raw sensor data, data that is further processed to form different types of joint dynamics, or some combination of both. A sensor may measure joint position (or a position of member(s) coupled at a hip joint 122_{H} and/or a knee joint 122_{K}) and systems of the robot 100 may perform further processing to derive velocity and/or acceleration from the positional data. In other examples, a sensor may measure velocity and/or acceleration directly.

When surveying a field of view F_{V} with a sensor, the sensor system 130 may generate sensor data (e.g., image data) corresponding to the field of view F_{V}. In some examples, the sensor data may be image data that corresponds to a three-dimensional volumetric point cloud generated by a three-dimensional volumetric image sensor. The image data may be based on reference features 14 situated within the site 10 that can be easily distinguished and observed by the sensors. Additionally or alternatively, when the robot 100 is maneuvering about the site 10, the sensor system 130 may gather pose data for the robot 100 that includes inertial measurement data (e.g., measured by an IMU). In some examples, the pose data includes kinematic data and/or orientation data about the robot 100, for example, kinematic data and/or orientation data about a hip joint 122_{H} and/or a knee joint 122_{K} or other portions of a leg of the robot 100. With the image data and the inertial measurement data, a perception system of the robot 100 may generate maps for the terrain about the site 10.

While the robot 100 maneuvers about the site 10, the sensor system 130 may gather sensor data relating to the terrain of the site 10 and/or structure of the robot 100 (e.g., joint dynamics and/or odometry of the robot 100). For example, the sensor system 130 may gather sensor data about a room of the site 10 of the robot 100. As the sensor system 130 gathers sensor data, a computing system may store, process, and/or communicate the sensor data (e.g., localization data) to various systems of the robot 100 (e.g., a control system, the perception system, an odometry system, and/or the localization module 101).

Based on the obtained sensor data, the localization module 101 may perform localization and identify a relative location and/or position of the robot 100 within the site 10. The localization module 101 may generate a localization output 102 based on performing the localization.

The localization module 101 may provide the localization output 102 to a control system 170 of the robot 100. The control system 170 may identify an action 103 of the robot 100 based on the localization output 102. For example, the action 103 may include instructing the robot 100 to move one or more legs or an arm of the robot 100, instructing the robot 100 to obtain sensor data from one or more sensors, instructing the robot 100 to provide an audio or visual output, instructing manipulation of an entity, object, obstacle, or structure within the site 10, etc. The control system 170 may cause performance of the action 103 (e.g., by causing actuation of one or more actuators of the robot 100).

In order to perform computing tasks related to the sensor data, the computing system of the robot 100 may include data processing hardware and memory hardware. The data processing hardware may execute instructions stored in the memory hardware to perform computing tasks related to activities (e.g., movement and/or movement-based activities) for the robot 100. In some cases, the computing system may refer to one or more locations of data processing hardware and/or memory hardware.

In some examples, the computing system may be a local system located on the robot 100. When located on the robot 100, the computing system may be centralized (e.g., in a single location/area on the robot 100 such as the body 110 of the robot 100), decentralized (e.g., located at various locations about the robot 100), or a hybrid combination of both (e.g., where a majority of centralized hardware and a minority of decentralized hardware). A decentralized computing system may allow processing to occur at an activity location (e.g., at motor that moves a joint of a leg) while a centralized computing system may allow for a central processing hub that communicates to systems located at various positions on the robot 100 (e.g., communicate to the motor that moves the joint of the leg). Additionally or alternatively, the computing system may include computing resources that are located remotely from the robot 100.

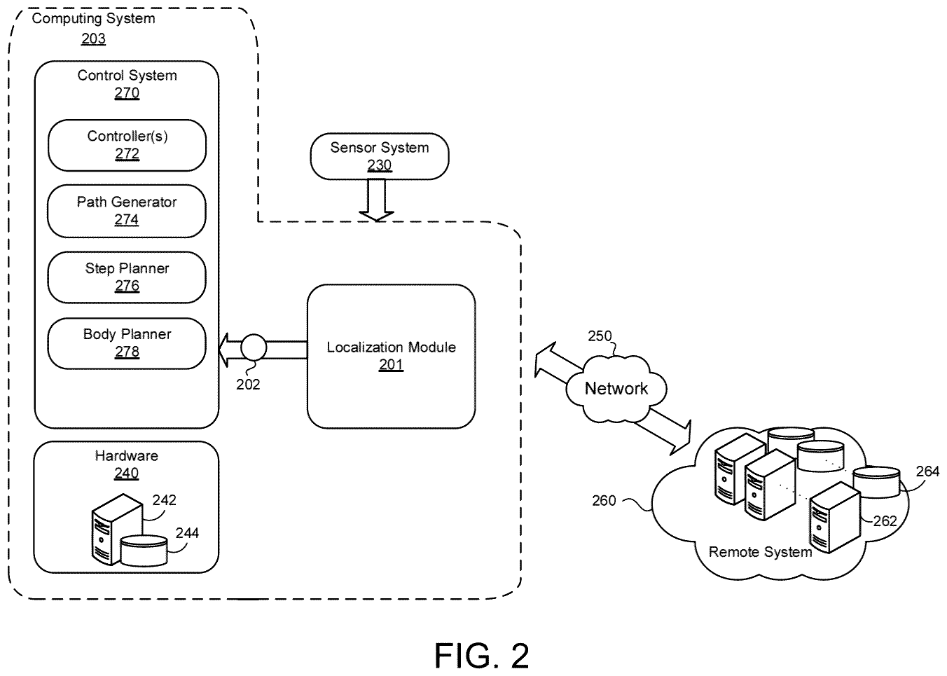

FIG. 2 is a schematic view of one or more systems of the robot of FIG. 1. The robot may include a computing system 203 (e.g., a local computing system) that is in communication with a sensor system 230. In some cases, the robot may include the sensor system 230. The computing system 203 may include a localization module 201, a control system 270 (which may be similar to and/or may include the control system 170), and hardware 240. The control system 270 may include one or more controllers 272, a path generator 274, a step planner 276, and/or a body planner 278. The hardware 240 may include data processing hardware 242 and memory hardware 244.

The computing system 203 may communicate via a network 250 with a remote system 260 (e.g., a remote computer/server or a cloud-based environment). The remote system 260 may include remote computing resources such as remote data processing hardware 262 and remote memory hardware 264. Sensor data and/or other processed data (e.g., data processing locally by the computing system 203) may be stored in the remote system 260 and may be accessible to the computing system 203. In some examples, the computing system 203 may utilize the remote resources as extensions of the computing resources of the computing system 203 such that resources of the computing system 203 may reside on resources of the remote system 260.

In some implementations, the robot may include a perception system. The perception system may receive sensor data from the sensor system 230 and process the sensor data to generate one or more maps. The perception system may communicate the one or more maps to the control system 270 in order to perform controlled actions for the robot, such as moving the robot about the site. In some examples, the perception system may be separate from, yet in communication with, the control system 270 such that the control system 270 may control the robot while the perception system may interpret the sensor data. For example, the control system 270 and the perception system may execute in parallel to ensure accurate, fluid movement of the robot in a site.

The perception system may help the robot move more precisely in terrain with various obstacles. As the sensor system 230 collects sensor data, the perception system may use the sensor data to form one or more maps of the site. Once the perception system generates a map, the perception system may add data to the map (e.g., by projecting sensor data on a preexisting map) and/or to remove data from the map.

The control system 270 may communicate with the sensor system 230 (or multiple sensor systems) and/or any other system of the robot (e.g., the perception system, an odometry system, and/or the localization module 201). In some cases, all or a portion of the sensor system 230 may be affixed to the body of the robot. In some cases, all or a portion of the sensor system 230 may be removably connected to the body of the robot. In some cases, all or a portion of the sensor system 230 may be located remotely from the body of the robot (e.g., all or a portion of the sensor system 230 may be located on the body of another robot, at a location within the site, etc.).

The control system 270 may perform operations and other functions using the hardware 240. For example, the control system 270 may perform operations using the data processing hardware 242 and/or may store data in the memory hardware 244.

The one or more controllers 272 may control movement of the robot to traverse about the site based on input or feedback from the systems of the robot (e.g., the control system 270, the perception system, the odometry system, and/or the localization module 201). This may include movement between poses and/or behaviors of the robot. For example, the one or more controllers 272 may control different footstep patterns, leg patterns, body movement patterns, or vision system sensing patterns.

In some examples, the one or more controllers 272 may include a set of controllers and all or a portion of the controllers may have or may be associated with a respective fixed cadence. A fixed cadence may refer to a fixed timing for a step or swing phase of a leg of the robot. For example, all or a portion of the controllers may instruct the robot to move the legs of the robot (e.g., take a step) at a particular frequency (e.g., step every 150 milliseconds, 350 milliseconds, etc.). The robot may experience variable timing by switching between controllers. In some cases, the robot can continuously switch between controllers and/or select a particular controller (e.g., re-select a controller every 3 milliseconds) as the robot traverses the site.

Referring to FIG. 2, the path generator 274 may determine horizontal motion for the robot. For example, the horizontal motion may refer to translation (e.g., movement in the X-Y plane) and/or yaw (i.e., rotation about the Z-direction axis A_{Z}) of the robot. The path generator 274 may determine obstacles within the site near the robot based on the sensor data.

The path generator 274 may communicate the obstacles (or an identifier of the obstacles) to the step planner 276 such that the step planner 276 may identify foot placements (e.g., touchdown locations) for legs of the robot (e.g., locations to place the distal ends of the legs of the robot). The step planner 276 may generate the foot placements for all or a portion of the steps of the robot using inputs from the perception system (e.g., one or more maps) and the localization module 201.

The body planner 278 may receive inputs from the perception system (e.g., one or more maps). The body planner 278 may adjust dynamics of the body of the robot (e.g., rotation, such as pitch or yaw and/or height of COM) to successfully move about the site.

As discussed below, the robot may include an odometry system. The odometry system may measure a characteristic of the robot relative to a reference. For example, the odometry system may generate odometry data as one or more estimations (e.g., measurements) for a characteristic of the robot relative to the reference. In some examples, the odometry system may receive sensor data from the sensor system 230. For example, the odometry system may receive sensor data from an inertial measurement unit that may include one or more accelerometers and/or one or more gyroscopes. The odometry system may generate odometry data based on an assumption that when a distal end of a leg of the robot is in contact with the ground surface and not slipping, the distal end is stationary. By combining this assumption with the sensor data, the odometry system may generate odometry data regarding robot motion relative to the reference. The odometry system may account for kinematics and inertial measurements to produce estimations about the robot with respect to the reference.

As shown in FIG. 2, the localization module 201 may evaluate the sensor data, the one or more maps, and the odometry data received from the systems (e.g., the sensor system 230, the perception system, the odometry system, and/or the localization module 201) to determine a localization output 202 indicating a location (e.g., a current location) and/or position of the robot within the site.

The control system 270 may use the localization output 202 (e.g., a speed, a direction, etc.) to estimate a location of the robot within the site based on movements of the robot relative to the prior location data. However, the localization output 202 may include noise associated with events (e.g., slips, obstructions) and drift (e.g., measurement error), which result in errors in the estimated location. Accordingly, the localization module 201 may periodically correct the estimated location of the robot based on sensor data obtained from the sensor system 230 (e.g., image data). For example, the localization module 201 may compare image data received from the sensor system 230 to a map generated by the perception system to determine the location of the robot relative to the map. The localization module 201 may adjust the localization output 202.

The control system 270 and the odometry system may use the localization output 202 to plan future movements and estimate locations within the site 10. However, in some situations, a map may not be associated with the site and/or the sensor data may be of poor quality, which may make accurate localization more difficult.

As discussed in greater detail below, to improve the reliability and the accuracy of the sensor data and the localization process, the localization module 201 may perform localization using variable types of sensor data. For example, the localization module 201 may perform localization using point cloud data, odometry data, satellite-based position data, etc. In some cases, the localization module 201 may perform localization using multiple types of data (e.g., point cloud data and satellite-based position data). In some cases, the localization module 201 may determine whether the sensor data satisfies (e.g., exceeds or matches) one or more thresholds (e.g., quality thresholds, reliability thresholds, etc.) and may use a first portion of the sensor data that satisfies the one or more thresholds to perform localization and may not use a second portion of the sensor data that does not satisfy the one or more thresholds to perform localization.

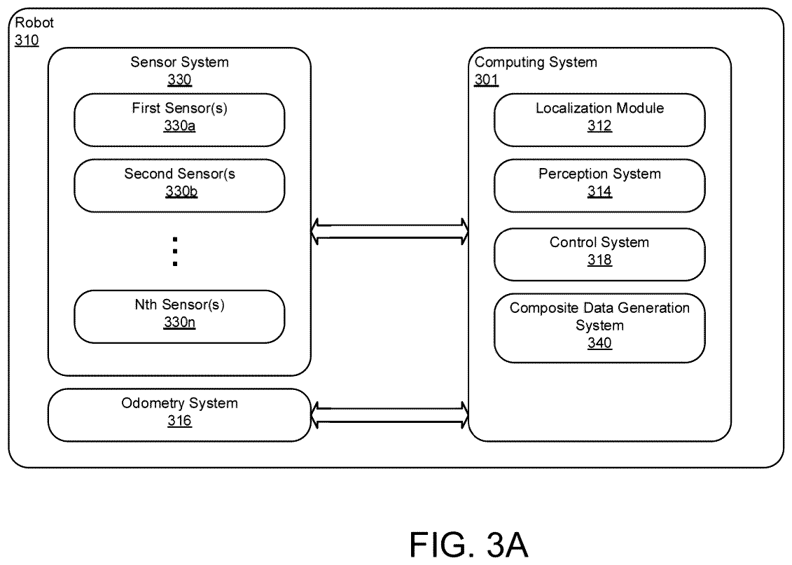

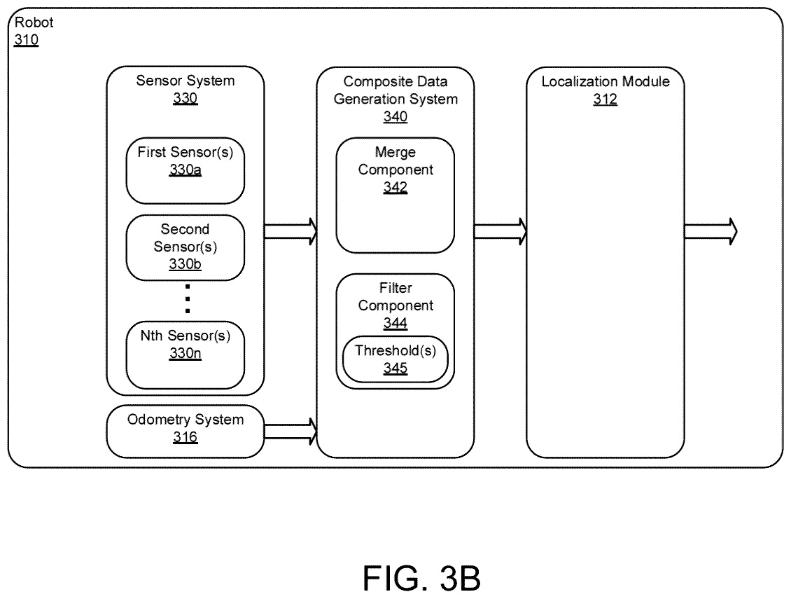

FIG. 3A is a schematic view of a sensor system 330 in communication with example systems of a robot 310. As discussed above with reference to FIG. 2, a robot 310, which may be similar to and/or may include the robot 100, can include a computing system 301 (which may be similar to and/or may include the computing system 203). The computing system 301 may include a localization module 312 (which may be similar to and/or may include the localization module 101 and/or the localization module 201), a perception system 314, a control system 318 (which may be similar to and/or may include the control system 170 and/or the control system 270), and/or a composite data generation system 340. The computing system 301 may be in communication with a sensor system 330, which may be similar to and/or may include the sensor system 130 and/or the sensor system 230, and/or an odometry system 316.

In some cases, the robot 310 may include all or a portion of the sensor system 330 and/or the odometry system 316. For example, all or a portion of the sensor system 330 and/or the odometry system 316 may be integrated within or affixed to a body of the robot 310. In some cases, the robot 310 may not include all or a portion of the sensor system 330 and/or the odometry system 316 (e.g., all or a portion of the sensor system 330 may be remote from the robot 310).

The sensor system 330 may include one or more first sensor(s) 330a, one or more second sensor(s) 330b, . . . , and one or more nth sensor(s) 330n where n can be any number. For example, the one or more first sensor(s) 330a may include one or more lidar sensors and the one or more second sensor(s) 330b may include one or more satellite-based position sensors. In some cases, all or a portion of the one or more first sensor(s) 330a, the one or more second sensor(s) 330b, . . . , and the one or more nth sensor(s) 330n may correspond to different types of sensors (e.g., satellite-based position sensors, inertial measurement units, lidar sensors, etc.)

In some cases, all or a portion of the one or more first sensor(s) 330a, the one or more second sensor(s) 330b, . . . , and the one or more nth sensor(s) 330n may be affixed or removably connected to the robot 310. For example, the one or more first sensor(s) 330a may include one or more lidar sensors that are affixed to the body of the robot 310 and the one or more second sensor(s) 330b may include one or more satellite-based position sensors that are removably connected to the body of the robot 310 (e.g., via a port).

The sensor system 330, via the one or more first sensor(s) 330a, the one or more second sensor(s) 330b, . . . , and the one or more nth sensor(s) 330n, can gather sensor data and communicate the sensor data to the computing system 301 of the robot 310. The computing system 301 can store, process, and/or communicate the sensor data to various systems of the robot 310 (e.g., the control system 318).

As discussed above, the odometry system 316 may measure a characteristic of the robot 310 relative to a reference (e.g., an internal reference frame, a world reference frame, etc.). For example, the odometry system 316 may generate sensor data (e.g., odometry data) that indicates one or more measurements of a characteristic of the robot 310 (e.g., a pose, a position, a location, a speed, etc. of the robot 310) relative to the reference. In some cases, the sensor system 330 may include all or a portion of the odometry system 316.

As discussed below, the sensor system 330 and the odometry system 316 may provide the sensor data to a composite data generation system 340 to generate composite data. For example, the sensor system 330 may provide point cloud data and satellite-based position data and the odometry system 316 may provide odometry data to the composite data generation system 340. The composite data generation system 340 may process the sensor data and generate composite data based on processing the sensor data. For example, the composite data generation system 340 may filter and/or merge the sensor data to generate the composite data.

The composite data generation system 340 may provide the composite data to the perception system 314. As discussed above, the perception system 314 may generate one or more maps based on the composite data (e.g., a body obstacle map, a step map, an obstacle map, a stair model, etc.).

The composite data generation system 340 may provide the composite data (e.g., as localization data) to the localization module 312 for localization of the robot 310. The perception system 314 may provide one or more maps to the localization module 312 for localization of the robot 310.

The localization module 312 may use the composite data and/or the one or more maps to perform a localization of the robot 310. In some cases, the localization module 312 may perform the localization in response to one or more instructions obtained from the computing system 301 (or a separate system).

Based on performing the localization, the localization module 312 may generate a localization output (e.g., indicating a location, a position, etc. of the robot with respect to the site). The localization module 312 may provide the localization output to the control system 318. In response to receiving the localization output, the control system 318 may perform one or more actions (e.g., instructing the robot 310 to move one or more legs or an arm of the robot 310, instructing the robot 310 to obtain sensor data from one or more sensors of the sensor system 330, instructing the robot 310 to provide an audio or visual output via one or more output devices of the robot 310, instructing manipulation of an entity, object, obstacle, or structure within the site, etc.) based on the localization of the robot 310. In some cases, the control system 318 may perform the action in response to one or more instructions obtained from the computing system 301 (or a separate system). In some cases, the control system 318 may perform the action in response to obtaining the localization output.

FIG. 3B is a schematic view of various systems of a robot 310. As discussed above with reference to FIG. 3A, the robot 310 may include the sensor system 330, the composite data generation system 340, the odometry system 316, the localization module 312, and one or more other systems (e.g., the perception system 314).

As discussed above, the sensor system 330 and the odometry system 316 may provide sensor data to the composite data generation system 340 to generate composite data. The composite data generation system 340 may process the sensor data and generate composite data based on processing the sensor data.

The composite data generation system 340 may include a merge component 342 and/or a filter component 344 to generate the composite data based on the sensor data. In some cases, the merge component 342 and/or the filter component 344 may be implemented by a processor of the composite data generation system 340. For example, the composite data generation system 340 may include one or more processors to merge and/or filter the sensor data.

In some cases, the merge component 342 and the filter component 344 may perform operations in parallel or in succession. For example, the filter component 344 may filter the sensor data and the merge component 342 may merge the filtered sensor data. In another example, the filter component 344 may filter the sensor data in parallel with the merge component 342 merging the sensor data.

The filter component 344 may obtain one or more threshold(s) 345 (e.g., threshold values, threshold ranges, etc.). For example, the one or more threshold(s) 345 may include reliability thresholds, quality thresholds, etc. The filter component 344 may obtain the one or more threshold(s) 345 from memory (e.g., a data store).

In some cases, the one or more threshold(s) 345 may be user-defined thresholds. For example, a computing system of the robot 310 may instruct display of a user interface via a computing device (e.g., a user computing device). The user interface may include a prompt or request to provide the one or more threshold(s) 345 for the sensor data. The computing system may obtain an input (containing or indicating the one or more threshold(s) 345) via the user interface. Based on the input, the computing system may define the one or more threshold(s) 345 and may store the one or more threshold(s) 345 in memory for access by the filter component 344.

In some cases, to filter the sensor data, the filter component 344 may compare the sensor data to the one or more threshold(s) 345. In some cases, the filter component 344 may compare the sensor data directly to the one or more threshold(s) 345. For example, the filter component 344 may compare a quantity of the sensor data (e.g., an amount of sensor data, whether any sensor data was obtained, etc.), a quality of the sensor data (e.g., a level of noise in the sensor data, a reliability, confidence, or uncertainty associated with the sensor data, etc.), etc. with the one or more threshold(s) 345. If the filter component 344 determines the sensor data is less than or matches the one or more threshold(s) 345, the filter component 344 may filter the sensor data.

In some cases, to filter the sensor data, the filter component 344 may compare metadata associated with the sensor data to the one or more threshold(s) 345. For example, the filter component 344 may compare a number (e.g., a quantity) of satellites associated with satellite-based position data, an age of a sensor by which the sensor data is obtained, a validation of the sensor data (e.g., using additional sensor data), a level of uncertainty associated with the sensor data, etc. with the one or more threshold(s) 345. If the filter component 344 determines a value associated with the metadata is less than or matches the one or more threshold(s) 345, the filter component 344 may filter the sensor data.

In some cases, to filter the sensor data, the filter component 344 may compare a first portion of the sensor data with a second portion of the sensor data. For example, the filter component 344 may compare the satellite-based position data to odometry data, determine a difference between the satellite-based position data and the odometry data (e.g., based on a position identified by the satellite-based position data and a position identified by the odometry data), determine if the difference is less than, matches, or exceeds the one or more threshold(s) 345, and filter the sensor data (e.g., filter out the satellite-based position data) if the difference matches or exceeds the one or more threshold(s) 345.

As discussed above, in some cases, the filter component 344 may filter the sensor data and/or provide the filtered sensor data to the merge component 342 to generate composite data. In some cases, in addition to or instead of filtering the sensor data, the filter component 344 may filter the composite data (e.g., composite data generated by the merge component 342).

The merge component 342 may merge the sensor data (e.g., the filtered sensor data) to generate composite data. In some cases, the merge component 342 may merge unfiltered sensor data. To generate the composite data, the merge component 342 may merge (e.g., fuse, combine, blend, unite, join, integrate, associate, etc.) the sensor data. For example, the merge component 342 may merge first sensor data from a first sensor with second sensor data from a second sensor and third sensor data from a third sensor to generate composite data. Further, the merge component 342 may merge sensor data associated with a set of data types (e.g., satellite-based position data, odometry data, point cloud data, etc.) to generate the composite data. In some cases, the merge component 342 may merge the sensor data by appending a first portion of the sensor data (associated with a first sensor) to a second portion of the sensor data (associated with a second sensor).

The merge component 342 may provide (e.g., assign, determine, identify) a weight (e.g., importance, influence, etc.) for all or a portion of the sensor data. For example, the merge component 342 may provide a respective weight for all or a portion of subsets of the sensor data corresponding to the set of data types (e.g., a first subset of the sensor data corresponds to point cloud data, a second subset of the sensor data corresponds to odometry data, a third subset of the sensor data corresponds to satellite-based position data). In some cases, the merge component 342 may provide a weight for all or a portion of the sensors of the sensor system 330 and/or the odometry system 316. For example, the merge component 342 may provide a first weight for the one or more first sensor(s) 330a (e.g., one or more lidar sensors) and a second weight for the one or more second sensor(s) 330b (e.g., one or more satellite-based position sensors) such that the merge component 342 assigns the respective weight to sensor data obtained from the respective sensors.

In some cases, the merge component 342 may provide a weight to all or a portion of the sensor data (or the sensors) based on one or more attributes (e.g., accuracy, reliability, confidence, quantity, quality, etc.) of the sensor data (or the sensors). For example, the merge component 342 may assign a first weight to first sensor data associated with a first accuracy and assign a second weight (that is less than the first weight) to second sensor data associated with a second accuracy (that is less than the first accuracy). By providing weights to the sensor data in such a manner, the merge component 342 can indicate a preference to utilize particular data (which may be more accurate as compared to other data). For example, while point cloud data corresponding to a feature rich site (e.g., a room corresponding to multiple features) may have a greater accuracy (for performing localization) as compared to position-based satellite data corresponding to the same site, position-based satellite data may have (e.g., generally) a greater accuracy as compared to point cloud data and/or odometry data across a set of different sites (e.g., an indoor site, an outdoor site, etc.).

In some cases, the merge component 342 may provide a same weight to a subset of the sensor data corresponding to a particular data type and obtained from a set of sensors. For example, the merge component 342 may provide a first weight to point cloud data obtained from a set of lidar sensors and a second weight to satellite-based position data obtained from a satellite-based position sensor.

In some cases, the merge component 342 may assign a weight to satellite-based position data that is greater (e.g., larger) as compared to the weights assigned to all or a portion of the other subsets of the sensor data. The merge component 342 may assign a weight to the satellite-based position data that is greater as compared to the other assigned weights to indicate that the satellite-based position data corresponds to a source of truth (e.g., a reference frame, a trusted data source, etc.). By indicating that the satellite-based position data is the source of truth, the merge component 342 may indicate a preference to rely on satellite-based position data to perform the localization.

The weights assigned to all or a portion of the sensor data may indicate how a system should use the sensor data to perform localization. For example, a first weight that is greater than a second weight may indicate that the system should utilize first sensor data assigned the first weight and not utilize second sensor data that is assigned the second weight. In another example, a first weight that is greater than a second weight may indicate that the system should utilize first sensor data assigned the first weight and not utilize second sensor data assigned the second weight for localization if the first sensor data and the second sensor data indicate different locations (e.g., a result of a localization based on the first sensor data is different as compared to a result of a localization based on the second sensor data).

By providing weights to different sensor data within composite data, the merge component 342 can indicate a preference to utilize first data (e.g., satellite-based position data) to perform localization, however, the merge component 342 can also use second data (e.g., point cloud data) to perform the localization in combination with the first data. The weights provided for the different sensor data may also indicate that a system is to use first data (e.g., satellite-based position data) to perform localization if the first data is available, however, if the first data is not available and/or does not satisfy one or more thresholds, the system may use second data (e.g., point cloud data) to perform localization.

In some cases, the weights may be site specific. For example, satellite-based position data may have a first weight in a first site (e.g., indoor) and a second weight that is greater than the first weight in a second site (e.g., outdoor). In another example, point cloud data may have a first weight in a feature rich site (e.g., a site corresponding to a number of features that satisfies a threshold) and a second weight that is less than the first weight in a feature desert (e.g., a site corresponding to a number of features that does not satisfy the threshold). Utilizing the weights, the composite data generation system 340 can prioritize particular data and/or deprioritize particular data in particular sites (e.g., prioritize satellite-based position data in an outdoor site, deprioritize satellite-based position data in an indoor site, etc.) such that the particular data is utilized (or utilized with a greater weight) in sites where the particular data is associated with greater attributes as compared to attributes of the data in other sites.

The composite data generation system 340 may provide the composite data to the localization module 312 for localization of the robot 310. The localization module 312 may use the composite data to perform a localization of the robot 310. Based on performing the localization, the localization module 312 may generate a localization output (e.g., indicating a location, a position, etc. of the robot with respect to the site). The localization module 312 may provide the localization output to a control system.

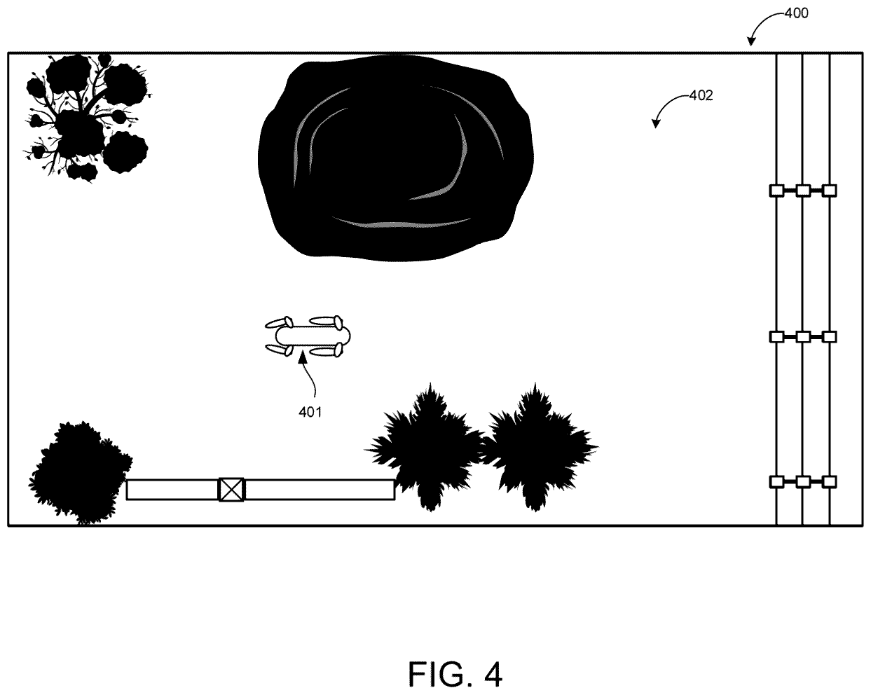

FIG. 4 is a schematic view 400 of a site 402. The site 402 may be similar to and/or may include the site 10. In the example of FIG. 4, the site 402 is depicted as an outdoor site, however, it will be understood that the site 402 may be a site that is within a building, a site that is underground or in a tunnel, etc. The schematic view 400 may be based on a view of the site 402. In some cases, the schematic view 400 may be based on a site model associated with the site 402. For example, the site model may include a virtual representation of one or more of a blueprint, a map, a computer-aided design (“CAD”) model, a floor plan, a facilities representation, a geo-spatial map, or a graph. In some cases, the schematic view 400 may be based on an overhead view of the site 402. For example, the overhead view of the site 402 may include a satellite-based view, a drone-based view, a plane-based view, etc. of the site 402. In some cases, the schematic view 400 may be captured by a sensor within the site 402. For example, the site 402 may include one or more image sensors (e.g., security cameras) that capture sensor data indicative of the schematic view 400.

The schematic view 400 includes a virtual representation of the site 402 and features within the virtual representation of the site 402. The virtual representation includes features corresponding to a set of trees, a feature corresponding to a body of water, a feature corresponding to a fence, a feature corresponding to power lines, etc. It will be understood that the virtual representation and the site 402 are illustrative only, and the virtual representation of the site 402 may include any features. Additionally, the features may be considerably more detailed than the schematic illustration of FIG. 4.

The schematic view 400 may indicate a robot 401 within the site 402. For example, the schematic view 400 may depict a robot that traverses the site 402. The robot 401 may be similar to and/or may include the robot 310 and/or the robot 100. As the robot 401 traverses the site 402, a computing system of the robot 401 may obtain sensor data associated with the site 402. For example, the computing system may obtain sensor data indicative of features within the site 402. In some cases, the robot 401 may traverse the site 402 to obtain sensor data and generate a map of the site 402. In some cases, the robot 401 may traverse the site 402 using a map (e.g., a previously generated map) and may localize within the site 402 using the map and obtained sensor data.

In some cases, the computing system may instruct display of the schematic view 400 via a user interface of a computing device. For example, the computing system may instruct display of the schematic view 400 to indicate a live representation of the robot 401 within the site and may continuously update the schematic view 400.

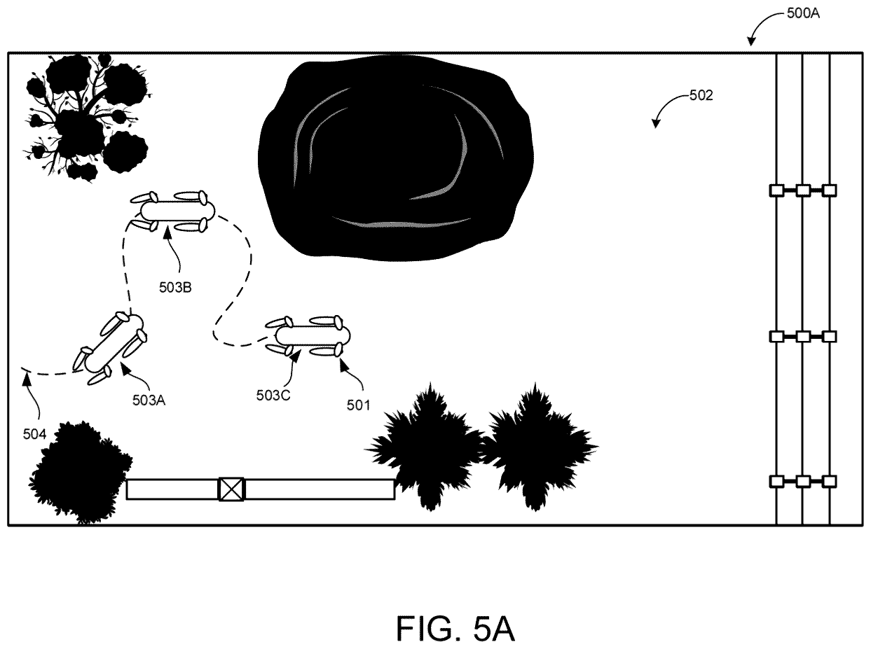

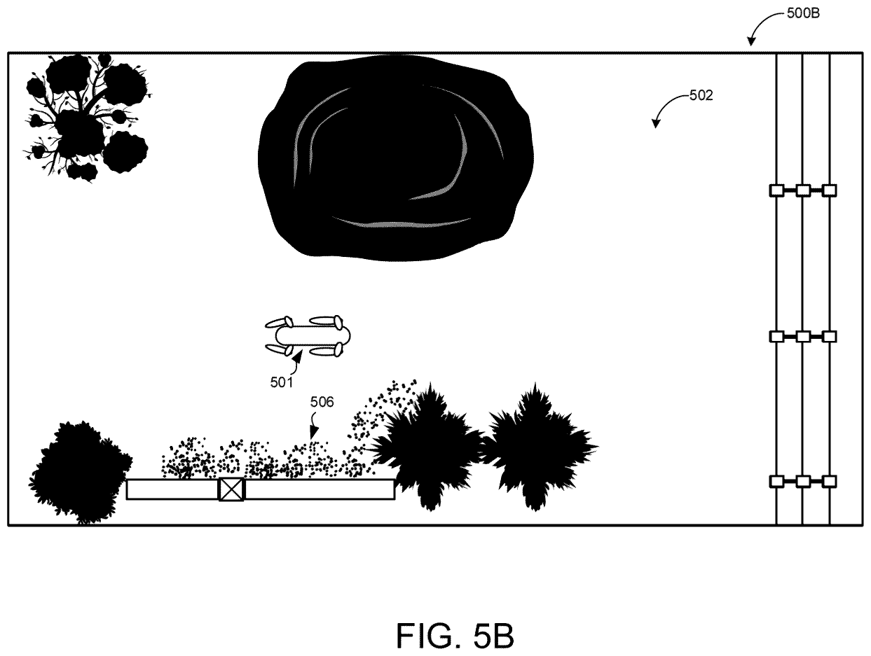

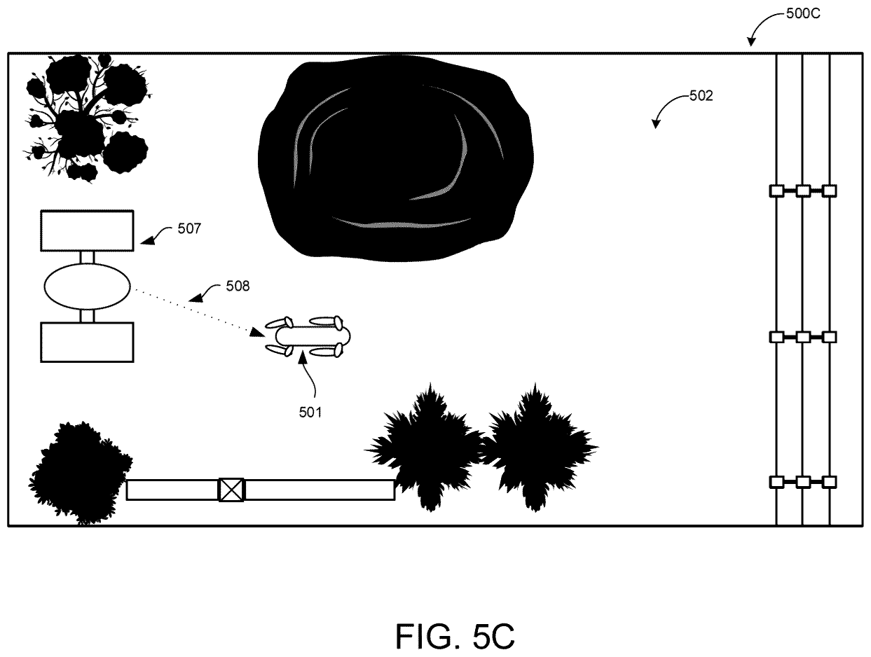

FIG. 5A is a schematic view 500A of a site 502 including a representation of odometry data 504 associated with a robot 501. The site 502 may be similar to and/or may include the site 402 and the robot 501 may be similar to and/or may include the robot 401.

During or subsequent to traversal of the site 502 by the robot 501, a computing system of the robot 501 may collect sensor data (e.g., odometry data 504). For example, the computing system may collect odometry data 504 indicating a route traversed by the robot 501 through the site.

The computing system may collect the odometry data 504 from one or more sensors (e.g., an inertial measurement unit). In some cases, the robot 501 may include an odometry system that collects sensor data from one or more sensors and generates the odometry data based on the collected sensor data.

The odometry data may include one or more estimations (e.g., measurements) for a characteristic of the robot 501 relative to a reference. For example, the characteristics may include a pose, a location, a position, an orientation, a velocity, an acceleration, etc. of the robot 501.

The computing system may collect odometry data 504 at various points within the site 502. For example, the computing system may collect odometry data 504 at one or more locations within the site 502 corresponding to one or more route waypoints. The computing system may collect odometry data 504 at a particular location within the site 502 and/or associate the collected odometry data with a route waypoint corresponding to the particular location within memory of the robot 501. In some cases, the computing system may continuously collect the odometry data 504 as the robot 501 traverses the site 502. In the example of FIG. 5A, the odometry data 504 indicates a first set of characteristics 503A (e.g., a first pose) of the robot 501 associated with a first location within the site 502, a second set of characteristics 503B (e.g., a second pose) of the robot 501 associated with a second location within the site 502, and a third set of characteristics 503C (e.g., a third pose, a current pose, etc.) of the robot 501 associated with a third location within the site 502.

As discussed above, the computing system, via an odometry system, may provide the odometry data 504 to a composite data generation system to generate composite data. The composite data generation system 340 may process the odometry data 504 and generate composite data based on processing the odometry data 504.

FIG. 5B is a schematic view 500B of a site 502 including a representation of point cloud data 506 (e.g., three-dimensional point cloud data) associated with the robot 501. During or subsequent to traversal of the site 502 by the robot 501, a computing system of the robot 501 may collect sensor data (e.g., the point cloud data 506).

The computing system may collect the point cloud data 506 from one or more sensors (e.g., one or more lidar sensors). The point cloud data 506 may include one or more sets of points (e.g., point clouds). The point cloud data 506 may be associated with one or more features representing entities, obstacles, objects, structures, etc. within the site 502. To identify the point cloud data 506 associated with the one or more features, the computing system can segment the point cloud data 506 (e.g., a single point cloud) into distinct subsets or clusters of the point cloud data 506 within the site 502. For example, the computing system can cluster (e.g., point cluster) the point cloud data 506 into a set of clusters of the point cloud data 506.

In some cases, the computing system (e.g., the filter component of the composite data generation system) can filter out subsets of the point cloud data 506 that correspond to particular features (e.g., representing ground surface, walls, desks, chairs, etc.). For example, a user, an operator, etc. may provide data to the computing system identifying features to filter out of the subsets of the point cloud data 506 (e.g., features that are not of interest) and features to maintain (e.g., features that are of interest).

The computing system can monitor (e.g., track) all or a portion of the distinct subsets of the point cloud data 506 to identify a feature. For example, the computing system can determine a particular subset of the point cloud data 506 is associated with (e.g., identifies) a particular feature. The computing system can store data associating the particular subset of the point cloud data 506 with the particular feature and monitor the particular feature. The computing system can monitor a feature over a period of time and over a set of positions of the robot 501 with respect to the site 502 (e.g., as the robot 501 traverses the site 502) by identifying a first subset of the point cloud data 506 obtained during a first time period and at a first position within the site 502 that corresponds to the feature and/or at a second subset of point cloud data obtained during a second time period and/or at a second position within the site 502 that corresponds to the feature. Therefore, the computing system can track the feature over time.

The computing system may collect point cloud data 506 at various points within the site 502. For example, the computing system may collect point cloud data 506 at one or more locations within the site 502 corresponding to one or more route waypoints. The computing system may collect point cloud data 506 at a particular location within the site 502 and associate the collected point cloud data with a route waypoint corresponding to the particular location within memory of the robot 501. In some cases, the computing system may continuously collect the point cloud data 506 as the robot 501 traverses the site 502. For example, a first portion of the point cloud data 506 may indicate a first point cloud associated with a first position of the robot 501 and a second portion of the point cloud data 506 may indicate a second point cloud associated with a second position of the robot 501.

As discussed above, the computing system may provide the point cloud data 506 to a composite data generation system to generate composite data. The composite data generation system 340 may process the point cloud data 506 and generate composite data based on processing the point cloud data 506.

FIG. 5C is a schematic view 500A of a site 502 including a representation of satellite-based position data 508 (e.g., Global Navigation Satellite System data, Satellite-Based Augmentation Systems data, Real-Time Kinematic data, etc.) associated with the robot 501. For example, the satellite-based position data 508 may be or may include global positioning system (“GPS”) data (e.g., raw GPS data). In another example, the satellite-based position data 508 may be or may include Satellite-Based Augmentation Systems data which may include one or more corrections (e.g., signal measurement error corrections) obtained from one or more relay satellites. In another example, the satellite-based position data 508 may be or may include Real-Time Kinematic data which may include one or more corrections (e.g., signal measurement error corrections) obtained from one or more reference stations (e.g., base stations). Prior to, during, or subsequent to traversal of the site 502 by the robot 501, a computing system of the robot 501 may collect sensor data (e.g., the satellite-based position data 508).

In some cases, the computing system may collect sensor data via an application programming interface. For example, a third party sensor may obtain satellite-based position data 508 and route the satellite-based position data 508 to the computing system via an application programming interface. In some cases, the third party sensor may be removably connected to the robot 501 via a port of the robot 501.

The computing system may collect the satellite-based position data 508 via one or more satellites 507. For example, the computing system may collect the satellite-based position data 508 from any number of satellites (e.g., three satellites, four satellites, etc.). Further, the computing system may include a receiver (e.g., a GPS receiver) to obtain the satellite-based position data.

In some cases, the computing system may obtain one or more signals from the one or more satellites 507 and generate the satellite-based position data 508 based on the one or more signals. The computing system may generate the satellite-based position data 508 by measuring the distance from the robot 501 (e.g., from the receiver of the robot 501) to the one or more satellites 507 based on the time between signals from the one or more satellites 507. By measuring the distance from the robot 501 (e.g., from the receiver of the robot 501) to the one or more satellites 507 based on the time between signals from the one or more satellites 507, the computing system can generate satellite-based position data 508 that may include a location (e.g., a longitude, a latitude, etc.), a position, an altitude, etc.

The computing system may collect satellite-based position data 508 at various points within the site 502. For example, the computing system may collect satellite-based position data 508 at one or more locations within the site 502 corresponding to one or more route waypoints. The computing system may collect satellite-based position data 508 at a particular location within the site 502 and associate the collected satellite-based position data with a route waypoint corresponding to the particular location within memory of the robot 501. In some cases, the computing system may continuously collect the satellite-based position data 508 as the robot 501 traverses the site 502. For example, a first portion of the satellite-based position data 508 may indicate a first satellite-based position of the robot 501 and a second portion of the satellite-based position data 508 may indicate a second satellite-based position of the robot 501.

As discussed above, the computing system may provide the satellite-based position data 508 to a composite data generation system to generate composite data. The composite data generation system 340 may process the satellite-based position data 508 and generate composite data based on processing the satellite-based position data 508.

As described above with respect to FIG. 5A, FIG. 5B, and FIG. 5C, the computing system may provide the odometry data 504, the point cloud data 506, and/or the satellite-based position data 508 to the composite data generation system to generate composite data. In some cases, the computing system may provide different data or different amounts of data for different sites and/or for different portions of the same site. For example, the computing system may provide odometry data 504 and point cloud data 506 to the composite data generation system for a first portion of the site 502 and odometry data 504 and satellite-based position data to the composite data generation system for a second portion of the site 502.

With respect to particular sites, particular data (e.g., particular types of data) may not be provided to a computing system of the robot. For example, the sensors of the robot may not capture particular types of data in particular sites and/or provide sensor data to the computing system of the robot for particular sites, sensor data associated with particular sites may not satisfy one or more thresholds, etc.

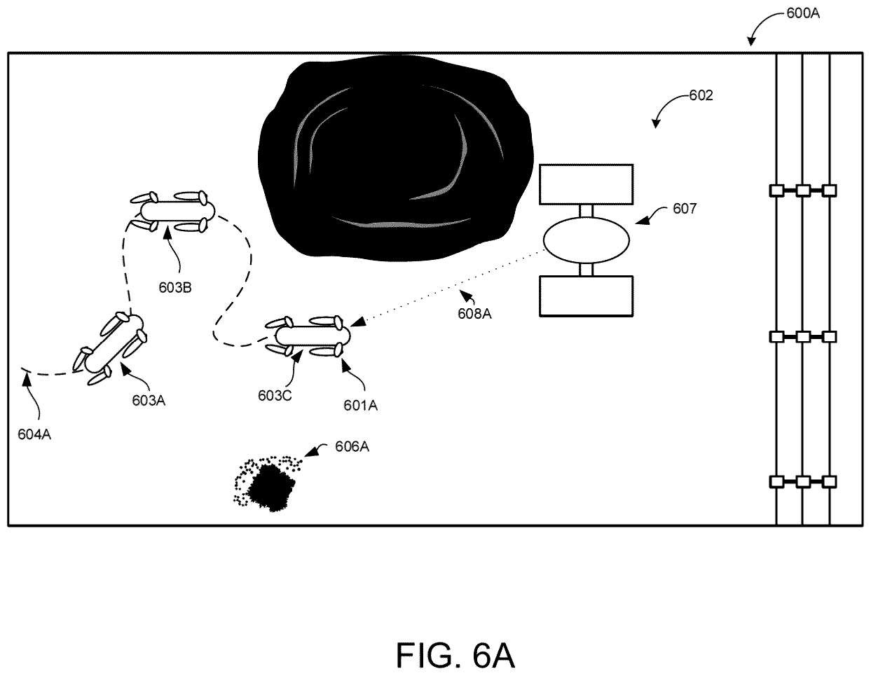

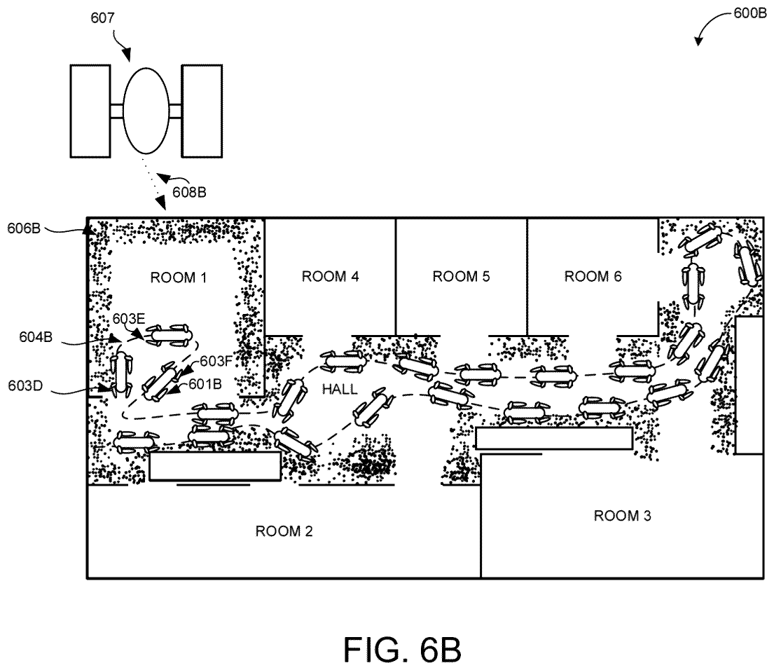

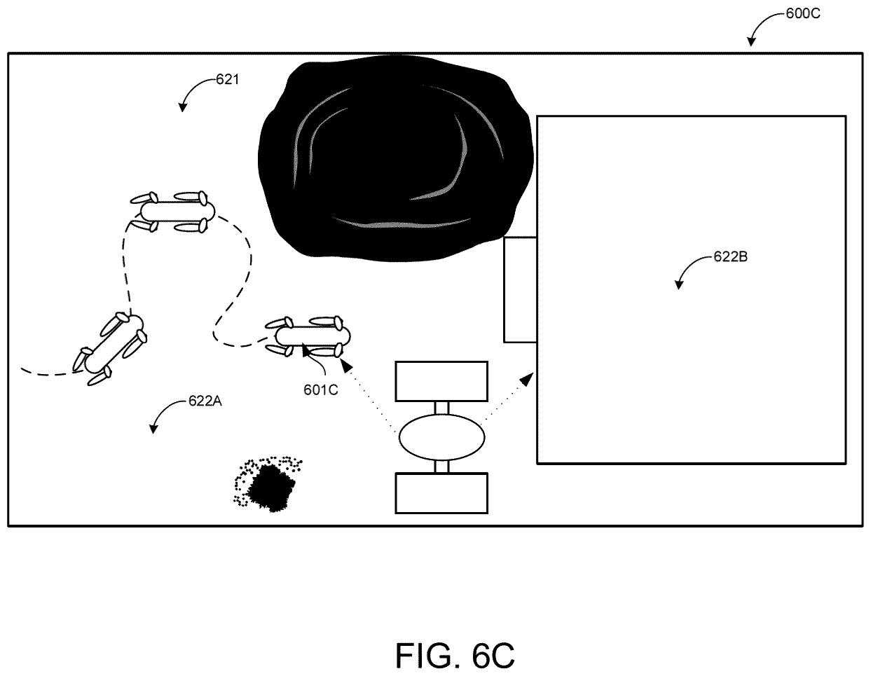

FIG. 6A is a schematic view 600A of a robot 601A using composite data to localize within a site 602. The site 602 may include an outdoor site (e.g., a site that is not within a building). While the site 602 may correspond to a number of features, the number of features may not satisfy a threshold (e.g., a threshold for performing localization using point cloud data alone) which may affect a localization performed using point cloud data and not satellite-based position data. However, the site 602 may provide access to one or more satellites such that a computing system can utilize satellite-based position data to perform localization. Additionally, the number of features corresponding to a site as indicated by the point cloud data may change (e.g., a human corresponding to a feature may move out of the site or to a different position in the site, a human or another robot may move a box corresponding to a feature out of the site or to a different position in the site, etc.). While access to one or more satellites at a site as utilized by a satellite-based position sensor may change (e.g., due to weather), the satellite-based position data may have a greater reliability, accuracy, etc. as compared to point cloud data (e.g., changes to the number of satellites accessible at a site may occur less than changes to a number of features corresponding to the site). To increase an accuracy and/or precision of the localization, the computing system can use the satellite-based position data with the point cloud data (and odometry data) to perform localization or can use the satellite-based position data instead of the point cloud data.

As discussed above, one or more sensors of the robot 601A may capture sensor data associated with the site 602. For example, one or more first sensors of the robot 601A may capture odometry data 604A, one or more second sensors of the robot 601A may capture point cloud data 606A, and one or more third sensors of the robot 601A may capture satellite-based position data 608A. All or a portion of the one or more sensors of the robot 601A may provide respective sensor data to the computing system of the robot 601A.

In some cases, one or more sensors of the robot 601A may not provide sensor data (e.g., may not provide an output to the computing system, may provide an empty data set or a null value, may return an error or otherwise indicate that sensor data was not captured, may not capture sensor data, etc.). For example, in a site without features (e.g., a desert, a barren region, etc.), a lidar sensor may not provide point cloud data due to the lack of features.

In some cases, one or more sensors of the robot 601A may provide sensor data, however, the attributes of the sensor data may not satisfy one or more thresholds (e.g., thresholds for performing localization using the sensor data). For example, in a site with a number of features that is less than a particular number (e.g., two features), while a lidar sensor may provide point cloud data, due to the number of features being less than the particular number, the point cloud data may have a quantity, a quality, etc. that is less than the one or more thresholds such that localization performed using the point cloud data may have a lower precision, accuracy, etc. as compared to a localization performed using satellite-based position data and/or odometry data (either alone or in combination with the point cloud data).

To increase a precision, accuracy, etc. of localization performed in such sites, a computing system may merge the sensor data to obtain composite data and may use the composite data to perform localization. For example, the computing system may merge satellite-based position data and point cloud data.

In the example of FIG. 6A, the sensor data obtained by the computing system may include odometry data 604A indicating a set of positions 603A, 603B, and 603C of the robot 601A, point cloud data 606A indicating a point cloud associated with a feature associated with the site 602, and satellite-based position data 608A indicate a satellite-based position of the robot 601A from one or more satellites 607.

Based on obtaining the sensor data, the computing system may filter and/or merge the sensor data to obtain composite data. The computing system may compare the sensor data collectively and/or individually to one or more thresholds to filter the sensor data. For example, the computing system may compare the odometry data 604A to one or more first thresholds (e.g., a threshold amount of time for capturing the odometry data 604A, a threshold distance over which the odometry data is captured, etc.), the point cloud data 606A to one or more second thresholds (e.g., a threshold number of points or point clouds, a threshold amount of space covered by points or point clouds, a threshold number of features indicated by the point cloud data, etc.), and the satellite-based position data to one or more third thresholds (e.g., a threshold number of satellites associated with the satellite-based position data, a threshold signal strength associated with the satellite-based position data, etc.). In some cases, the computing system may compare all or a portion of the sensor data with the same one or more thresholds. For example, the one or more thresholds may be a quantity of the sensor data (e.g., an amount of sensor data, whether any sensor data was obtained, etc.), a quality of the sensor data (e.g., a level of noise in the sensor data, a reliability, confidence, or uncertainty associated with the sensor data, etc.), etc.

In the example of FIG. 6A, as the site 602 is an outdoor site, the computing system may determine that the satellite-based position data 608A satisfies one or more thresholds (e.g., the satellite-based position data 608A is associated with a number of satellites that exceeds or matches a threshold number). Further, the computing system may determine the point cloud data 606A does not satisfy the one or more thresholds (e.g., the point cloud data 606 indicates a number of point clouds that is less than or matches a threshold number) and the odometry data 604A does not satisfy one or more thresholds (e.g., the odometry data 604A is associated with a time period that is less than or matches a threshold time period).

Based on determining the satellite-based position data 608A satisfies the one or more thresholds and the odometry data 604A and the point cloud data 606A do not satisfy the one or more thresholds, the computing system may provide the satellite-based position data 608A to a merge component of the composite data generation system to generate the composite data and may not provide the odometry data 604A and the point cloud data 606A to the merge component of the composite data generation system (e.g., a filter component of the composite data generation system may filter out the odometry data 604A and the point cloud data 606A from the sensor data). The composite data generated by the composite data generation system may reflect the satellite-based position data 608A (e.g., based on the computing system providing the satellite-based position data 608A to the merge component) but may not reflect the odometry data 604A and the point cloud data 606 (e.g., based on the computing system not providing the odometry data 604A and the point cloud data 606 to the merge component).

FIG. 6B is a schematic view 600B of a robot 601B using composite data to localize within the site 612. The site 612 may include an indoor site (e.g., a site that is located within a building).

As discussed above, one or more sensors of the robot 601B may capture sensor data associated with the site 612. For example, one or more first sensors of the robot 601B may capture odometry data 604B, one or more second sensors of the robot 601B may capture point cloud data 606B, and one or more third sensors of the robot 601B may capture satellite-based position data 608B. All or a portion of the one or more sensors of the robot 601B may provide respective sensor data to the computing system of the robot 601B.

In the example of FIG. 6B, the sensor data obtained by the computing system may include odometry data 604B indicating a set of positions 603D, 603E, and 603F of the robot 601B, point cloud data 606B indicating a set of point clouds associated with a set of features associated with the site 612, and satellite-based position data 608B indicate a satellite-based position of the robot 601B from the one or more satellites 607.

As discussed above, the computing system may compare the sensor data to one or more thresholds to filter the sensor data. In the example of FIG. 6B, as the site 612 is an indoor site, the computing system may determine that the satellite-based position data 608B does not satisfy one or more thresholds (e.g., a building is blocking the computing system from obtaining a particular amount of satellite-based position data, the computing system is obtaining satellite-based position data from a number of satellites that is less than or matches a threshold number, etc.). Further, the computing system may determine the point cloud data 606B does satisfy the one or more thresholds (e.g., the point cloud data 606 indicates a number of point clouds that exceeds or matches a threshold number) and the odometry data 604B does satisfy one or more thresholds (e.g., the odometry data 604B is associated with a time period that exceeds or matches a threshold time period).

Based on determining the satellite-based position data 608B does not satisfy the one or more thresholds and the odometry data 604B and the point cloud data 606B do satisfy the one or more thresholds, the computing system may provide the odometry data 604B and the point cloud data 606B to the merge component to generate the composite data and may not provide the satellite-based position data 608B to the merge component. The composite data generated by the composite data generation system may reflect the odometry data 604B and the point cloud data 606B but may not reflect the satellite-based position data 608B.

FIG. 6C is a schematic view 600C of a robot 601C using composite data to localize within the site 621. The site 621 may include an outdoor site 622A and an indoor site 622B (e.g., a site that is located within a building). As the site 621 may include the outdoor site 622A and the indoor site 622B, the computing system may not obtain particular data at particular portions of the site. For example, the computing system may not obtain satellite-based position data in the indoor site 622B (or may obtain satellite-based position data associated with a number of satellites that does not satisfy a threshold) and may obtain satellite-based position data in the outdoor site 622A (e.g., may obtain satellite-based position data associated with a number of satellites that satisfies a threshold). In another example, the computing system may not obtain point cloud data in the outdoor site 622A (or may obtain point cloud data associated with a number of point clouds that does not satisfy a threshold) and may obtain point cloud data in the indoor site 622B (e.g., may obtain point cloud data associated with a number of point clouds that satisfies the threshold).

As the robot 601C traverses the site 621, the computing system may obtain composite data corresponding to different data types depending on the sensor data obtained by the computing system. The computing system may provide a different weight for the composite data based on the position of the robot 601C relative to the site and/or the obtained sensor data. For example, the computing system may provide a first weight for satellite-based position data associated with a number of satellites that satisfies a threshold and a second weight that is less than the first weight for satellite-based position data associated with a number of satellites that does not satisfy the threshold.

The computing system may seamlessly perform localization as the robot 601C traverses the site 621 (e.g., between the indoor site 622B and the outdoor site 622A) by using the composite data (e.g., the weighted composite data). Therefore, the computing system can perform localization in portions of the site 621 where the computing system may not obtain particular data (e.g., in the outdoor site where the computing system may not obtain point cloud data).

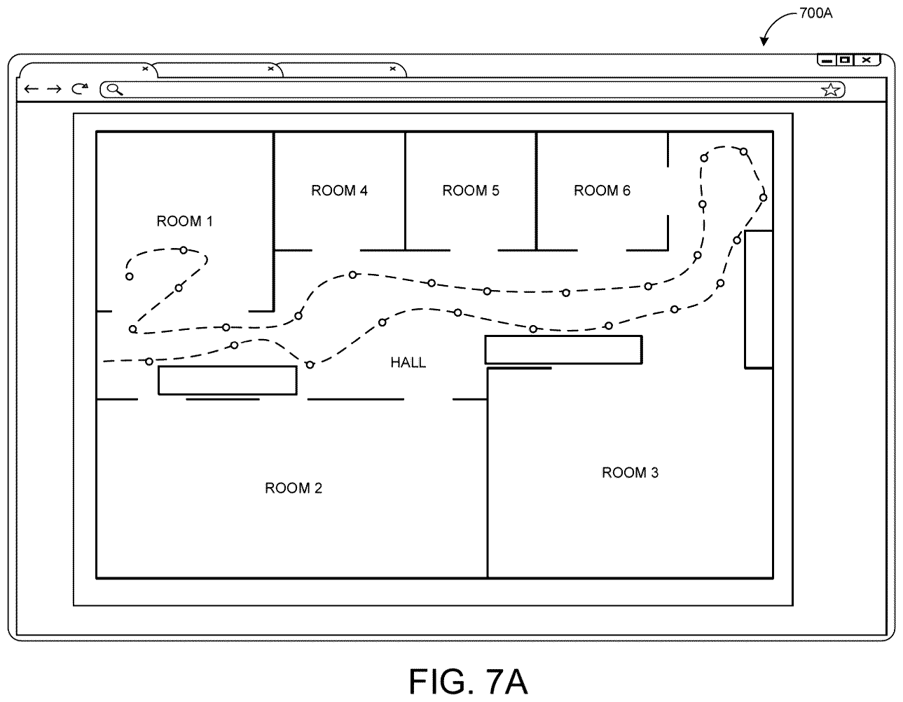

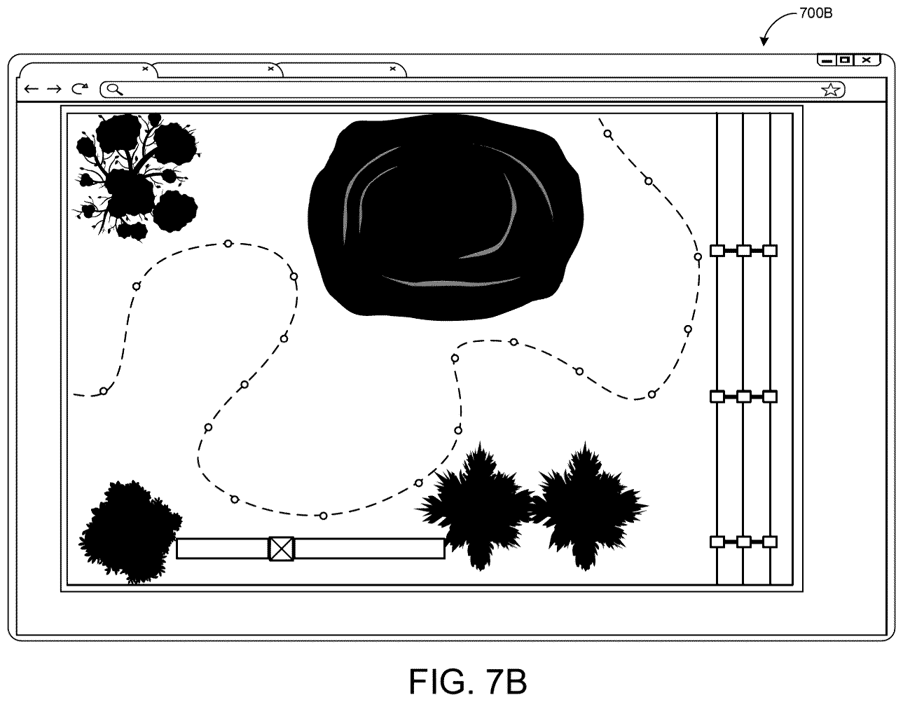

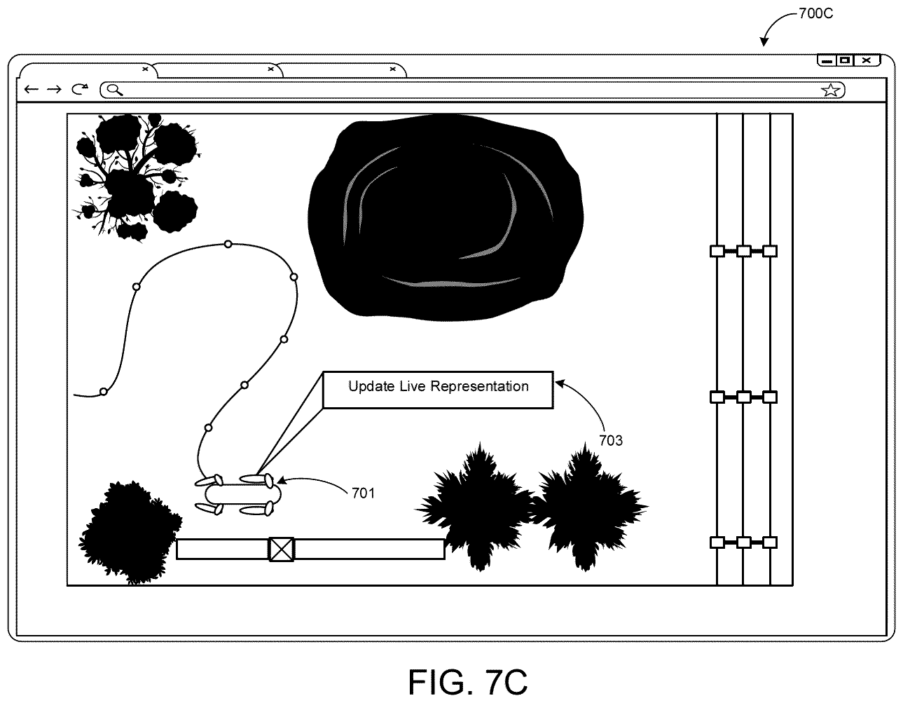

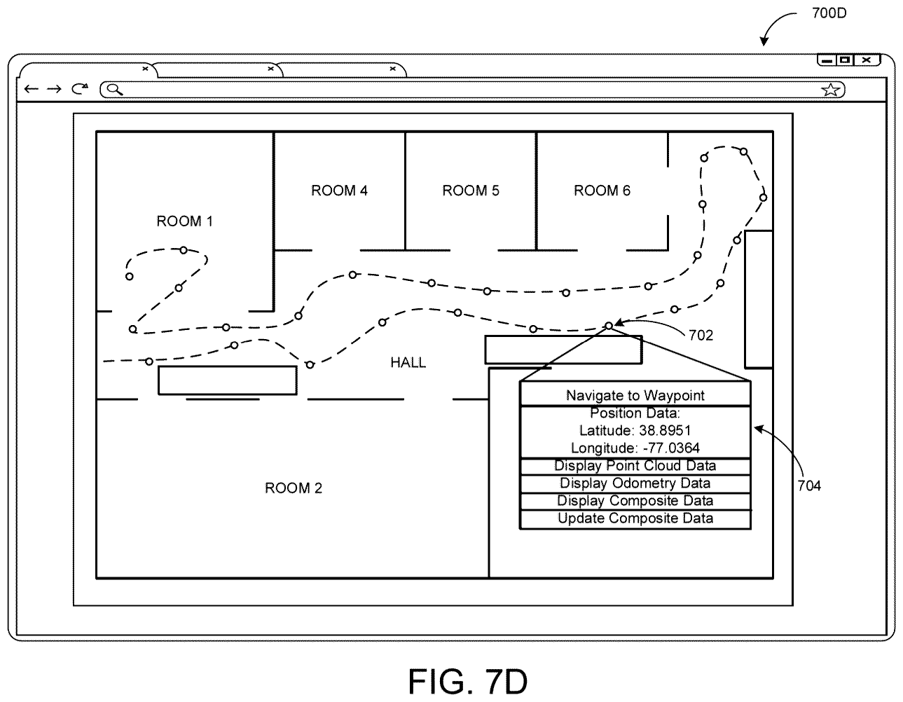

FIG. 7A depicts a schematic view of an example user interface 700A including composite data overlaid on a representation of a site. In the example of FIG. 7A, the site may be an indoor site (e.g., a site within a building). The user interface 700A reflects odometry data (e.g., a virtual representation of a route) relative to (e.g., overlaid on) a site map (e.g., a blueprint). For example, the user interface 700A may reflect a route of a robot including one or more route waypoints and one or more route edges.

In some cases, based on the odometry data, the user interface 700A may reflect one or more estimations (e.g., measurements) for one or more characteristics (e.g., a pose, a location, a position, an orientation, a velocity, an acceleration, etc.) of the robot relative to the site. For example, the characteristics may include a distance traveled by the robot.

In some cases, the user interface 700A may reflect point cloud data and/or satellite-based position data. For example, the user interface 700A may reflect a latitude of the robot, a longitude of the robot, one or more point clouds, etc.

To provide a user interface 700A that reflects point cloud data, satellite-based position data, and/or odometry data overlaid on a representation of the site, a computing system may register (e.g., separately) all or a portion of the point cloud data, the satellite-based position data, and/or the odometry data to the site. For example, the computing system may identify a first relationship between the point cloud data (or a representation of the point cloud data) and the site (or a representation of the site), a second relationship between the satellite-based position data (or a representation of the satellite-based position data) and the site (or the representation of the site), etc. and may register the sensor data using the relationships.

To identify the relationships between the point cloud data, the satellite-based position data, and/or the odometry data and the site, the computing system may generate the composite data by temporally aligning the point cloud data, the satellite-based position data, and/or the odometry data based on one or more timestamps. The computing system may identify a first relationship between one or more of the point cloud data, the satellite-based position data, and/or the odometry data and the site using a manner of registration as discussed below and can identify one or more second relationships between the other of the point cloud data, the satellite-based position data, and/or the odometry data using the first relationship and the temporal alignment of the point cloud data, the satellite-based position data, and/or the odometry data.

Based on the relationships, the computing system may identify a relationship between at least a portion of the composite data (e.g., the point cloud data, the satellite-based position data, the odometry data, etc.) and/or the site and a physical coordinate system (e.g., one or more physical coordinates relative to the Earth). For example, the computing system may identify a position of one or more point clouds, a position of a site, a route of a robot, a position of a fiducial, etc. with respect to the Earth (e.g., as a longitude and a latitude). The computing system may cause display of a user interface based on the relationships (e.g., indicative of one or more point clouds relative to the Earth).

In some cases, the computing system may utilize different manners of registration for all or a portion of the point cloud data, the satellite-based position data, and/or the odometry data. For example, the computing system may utilize a first manner of registration for the point cloud data, a second manner of registration for the satellite-based position data, a third manner of registration for the odometry data, etc.

To illustrate an example of the first manner of registration, the computing system may identify a relationship between the point cloud data and the site by performing point cloud matching. For example, the computing system may identify a point cloud of the point cloud data, may identify a feature corresponding to the site (e.g., as indicated by a representation of the site), may identify a relationship (e.g., a match) between the feature and the point cloud, and may identify a relationship between the point cloud data and the site (e.g., may register all or a portion of the point cloud data to a particular location within a representation of the site).

To illustrate an example of the second manner of registration, the computing system may identify a relationship between the satellite-based position data and the site by matching satellite-based position data to satellite-based position data associated with the site. For example, the computing system may identify satellite-based position data of a robot, may identify a representation of the site (e.g., a satellite view of the site), may identify satellite-based position data associated with the representation of the site (e.g., coordinates associated with the site) and may identify a relationship (e.g., a match) between a portion of the satellite-based position data associated with the representation of the site (e.g., particular coordinates) and the satellite-based position data of the robot, and may identify a relationship between the satellite-based position data of the robot and the site (e.g., may register all or a portion of the satellite-based position data of the robot to a particular location within a representation of the site).

To illustrate an example of the third manner of registration, the computing system may identify a relationship between the odometry data and the site using a fiducial (e.g., associated with a dock) associated with the site. For example, the computing system may identify odometry data of the robot relative to a fiducial, may identify a position of the fiducial relative to a representation of the site (e.g., a location of the fiducial within the representation of the site), and may identify a relationship between the odometry data and the site using the position of the fiducial relative of the representation of the site (e.g., may register all or a portion of the odometry data to a particular location within a representation of the site).

A computing system of the robot may instruct display of the user interface 700A based on traversal of the site by the robot (and/or generation of composite data). As discussed below, the user interface 700A may enable a user to select all or a portion of the sensor data and update the sensor data.

FIG. 7B depicts a schematic view of an example user interface 700B including composite data overlaid on a representation of a site. In the example of FIG. 7B, the site may be an outdoor site (e.g., a site not within a building). The user interface 700B reflects odometry data (e.g., a virtual representation of a route) relative to (e.g., overlaid on) a site map (e.g., a satellite view of the site).

As discussed above with reference to FIG. 7A, based on the odometry data, the user interface 700B may reflect one or more estimations and/or one or more characteristics of the robot relative to the site. In some cases, the user interface 700B may reflect point cloud data and/or satellite-based position data.

A computing system of the robot may instruct display of the user interface 700B and may enable a user, via the user interface 700B, to select all or a portion of the sensor data and update the sensor data.

FIG. 7C depicts a schematic view of an example user interface 700C including a representation of a robot 701 overlaid on a representation of a site (e.g., a satellite view of the site). The user interface 700C may include or may be similar to the user interface 700B. As discussed above, the user interface 700C may include composite data associated with the robot 701 overlaid on the representation of the site. In the example of FIG. 7C, the composite data includes odometry data, however, it will be understood that the composite data may include more, less, or different data.

The user interface 700C may provide a live representation of the robot 701 with respect to (e.g., overlaid on) a representation of the site. For example, the user interface 700C may include a pictorial representation of the robot 701 that is overlaid on pictorial representation of the site and is updated to provide a live representation of the position of the robot 701 with respect to the representation of the site.

The user interface 700C may provide an element 703 that enables a user to request an update to the live representation of the robot 701. In the example of FIG. 7C, the element 703 includes the text “Update Live Representation.” In response to an interaction with the element 703, a computing system of the robot 701 may obtain updated composite data associated with the robot 701 and update the live representation of the robot 701 with respect to the representation of the site. In some cases, the computing system may obtain an updated representation of the site and may update the live representation of the robot 701 with respect to the updated representation of the site.

In some cases, the computing system may continuously and/or automatically update the live representation of the robot 701 such that the user interface 700C provides a continuously and/or automatically updated live representation of the robot 701 with respect to the representation of the site.

FIG. 7D depicts a schematic view of an example user interface 700D including composite data overlaid on a representation of a site (e.g., a satellite view of the site). The user interface 700D may include or may be similar to the user interface 700A. As discussed above, the user interface 700D may include composite data associated with the robot 701 overlaid on the representation of the site. In the example of FIG. 7D, the composite data includes odometry data, however, it will be understood that the composite data may include more, less, or different data.

The user interface 700D may provide an element 704 that enables a user to provide an input. The user interface 700D may provide the element 704 based on an interaction, received from a computing device, with a route waypoint associated with the composite data. For example, the interaction may be based on a user clicking on, hovering over, or otherwise interacting with the route waypoint.

The element 704 may identify the composite data and/or enable a user to interact with the composite data. For example, the element 704 may enable a user to select a particular portion of the composite data for display overlaid on the representation of the site, to update a particular portion of the composite data, to instruct the robot to navigate to a particular satellite-based position or route waypoint, etc.

In the example of FIG. 7D, the element 704 includes the options to “Navigate to Waypoint,” “Position Data: Latitude: 38.8951 Longitude: −77.0364,” “Display Point Cloud Data,” “Display Odometry Data,” “Display Composite Data,” and “Update Composite Data.” For example, based on an interaction with the element 704, the user interface 700D may display point cloud data, odometry data, composite data, satellite-based position data (e.g., a latitude and/or a longitude), etc. associated with a route waypoint.

In some cases, the element 704 may enable the composite data to be updated. For example, a user may interact with the element 704 to filter the composite data, define filters for the composite data, adjust a relationship between the composite data and the site, etc. In some cases, the computing system may obtain the updated composite data based on the input and may display the updated composite data with respect to the updated representation of the site.

In some cases, the computing system may continuously and/or automatically update the composite data such that the user interface 700d provides continuously and/or automatically updated composite data with respect to the representation of the site.

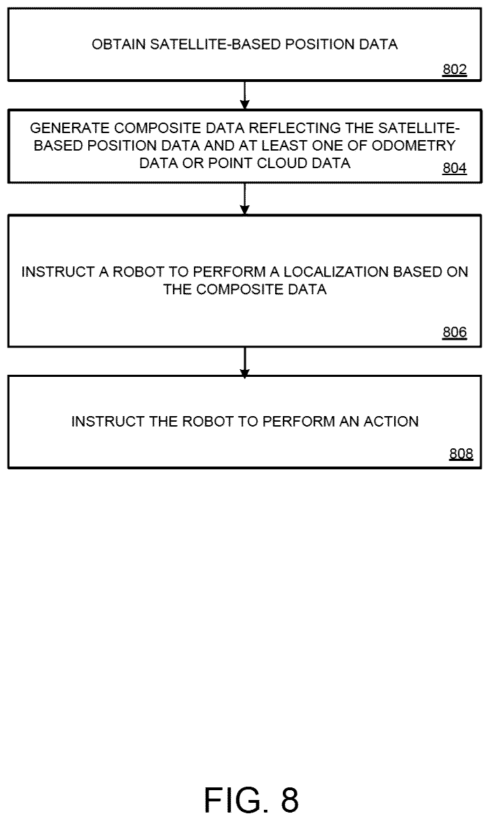

FIG. 8 shows a method 800 executed by a computing system to operate a robot (e.g., by instructing the robot to perform a localization and an action) based on composite data associated with the robot, according to some examples of the disclosed technologies. For example, the robot may be a legged robot with a set of legs (e.g., two or more legs, four or more legs, etc.), memory, and a processor. Further, the computing system may be a computing system of the robot. In some cases, the computing system of the robot may be located on and/or part of the robot. In some cases, the computing system of the robot may be distinct from and located remotely from the robot. For example, the computing system of the robot may communicate, via a local network, with the robot. The computing system may be similar, for example, to the sensor system 330, the computing system 301, and/or the odometry system 316 as discussed above, and may include memory and/or data processing hardware.

At block 802, the computing system obtains satellite-based position data (e.g., in real time). For example, the computing system may obtain the satellite-based position data from at least one satellite-based position sensor (e.g., a receiver). The satellite-based position sensor may be removably connected to the body of the robot (e.g., via a port of one or more ports of the robot) such that the satellite-based position sensor is detachable from the robot. The satellite-based position data may represent a set of positions (e.g., one or more positions) of the robot within a site of the robot. The satellite-based position data may include GPS data (e.g., raw GPS data). For example, the satellite-based position data may include one or more raw GPS coordinates. In another example, the satellite-based position data may include one or more latitudes and/or one or more longitudes.

In some cases, the computing system may obtain satellite-based image data (e.g., one or more satellite tiles) representing an image of the site (e.g., a satellite view of the site). For example, the computing system may obtain the satellite-based image data from one or more satellites. Based on the satellite-based image data, the computing system may identify a representation of the satellite view of the site (e.g., a pictorial representation).

The computing system may generate a user interface that includes the satellite-based position data, the point cloud data, the odometry data, and/or the composite data overlaid on a representation of the site (e.g., a site model, the representation of the satellite view of the site). In some cases, the user interface may include the satellite-based position data, the point cloud data, the odometry data, and/or the composite data overlaid on the satellite-based image data. In some cases, the user interface may include one or more of one or more obstacles, one or more objects, one or more entities, one or more structures, a terrain of the site, one or more route waypoints, one or more route edges, etc. overlaid on and/or displayed with respect to the representation of the site.

The computing system may instruct display of the user interface (e.g., via a user computing device). In some cases, the computing system may receive an input via the user interface and may instruct movement of the robot based on the input. For example, the computing system may instruct the robot to navigate to a location (e.g., a waypoint) within the site based on the input.

The computing system may periodically or aperiodically update the user interface to obtain an updated user interface. In some cases, the computing system may update the user interface in real time (e.g., as composite data is generated, as sensor data is obtained, etc.). For example, the computing system may update the user interface in real time to provide a live representation of a position of the robot within the site. In some cases, the computing system may obtain an input via the user interface and may update the user interface, the satellite-based position data, the point cloud data, the odometry data, and/or the composite data based on the input. The computing system may instruct display of the updated user interface.

At block 804, the computing system generates composite data (e.g., merged data, fused data, localization data, etc.) reflecting the satellite-based position data and at least one of odometry data or point cloud data. In some cases, the composite data may reflect the satellite-based position data, the odometry data, and the point cloud data. The odometry data may be based on one or more steps of one or more legs of the robot. For example, the odometry data may indicate movement of the robot through the site relative to a reference. The point cloud data may indicate one or more point clouds associated with one or more features of the site.

In some cases, the composite data may further include and/or reflect at least one of ground plane data (e.g., indicating a position or distance from a ground plane), step location data (e.g., indicating a location of one or more steps of the robot), fiducial data (e.g., indicating a fiducial, a position of the fiducial, etc.), loop closure data (e.g., indicating a performed loop closure), a user annotation (e.g., indicating edited or updated composite data, indicating areas to not enter based on the composite data, areas to enter based on the composite data, etc.), a stair model (e.g., indicating a staircase, a position of one or more stairs), height data (e.g., one or more heights), texture data (e.g., one or more textures), etc. For example, a user annotation may indicate that the robot is not to enter a particular area as defined by satellite-based position data (e.g., one or more latitudes and/or longitudes).

To generate the composite data, the computing system may associate all or a portion of the set of positions of the robot with at least one of a portion of the odometry data or a portion of the point cloud data. For example, the computing system may associate a position of the robot with odometry data and point cloud data.

In some cases, to generate the composite data, the computing system may merge the satellite-based position data and at least one of odometry data or point cloud data. For example, the computing system may merge the satellite-based position data and at least one of odometry data or point cloud data by appending the odometry data and/or the point cloud data to the satellite-based position data.

The computing system may filter at least a portion of at least one of the satellite-based position data, the odometry data, or the point cloud data prior to generation of the composite data. In some cases, the computing system may filter the composite data. The computing system may filter the composite data, the satellite-based position data, the odometry data, and/or the point cloud data using one or more thresholds. For example, the one or more thresholds may indicate a threshold number of satellites to be associated with the satellite-based position data, a threshold level of certainty or uncertainty associated with the sensor data (e.g., the satellite-based position data), etc.

In some cases, the computing system may filter the composite data, the satellite-based position data, the odometry data, and/or the point cloud data based on the composite data, the satellite-based position data, the odometry data, and/or the point cloud data. In some cases, the computing system may filter the composite data to remove all or a portion of at least one of the satellite-based position data, the odometry data, and/or the point cloud data from the composite data based on the one or more thresholds. For example, the computing system may filter at least a portion of the satellite-based portion data from the composite data based on the odometry data (e.g., based on receiving odometry data).

To filter the composite data, the satellite-based position data, the odometry data, and/or the point cloud data, the computing system may compare one or more values of the composite data, the satellite-based position data, the odometry data, and/or the point cloud data to the one or more thresholds (e.g., one or more reliability thresholds). Based on the comparison, the computing system may determine the one or more values are less than, match (e.g., are equal to), or exceed the one or more thresholds. In response to determining the one or more values are less than (or match in some cases) the one or more thresholds, the computing system may filter the one or more values from the composite data, the satellite-based position data, the odometry data, and/or the point cloud data. For example, the computing system may determine that one or more values associated with the point cloud data are less than or match the one or more thresholds and, in response to or based on the determination, the computing system may generate the composite data and filter the point cloud data from the composite data such that the composite data may reflect the satellite-based position data and/or the odometry data but not the point cloud data.

The computing system may obtain sensor data including the odometry data, the point cloud data, etc. from one or more sensors (e.g., one or more first sensors). For example, the one or more sensors may include a camera (e.g., a stereo camera), a lidar sensor, a ladar sensor, a radar sensor, a sonar sensor, etc. In some cases, the composite data may reflect additional sensor data (e.g., radar data, image data, etc.). In some cases, the point cloud data may include three-dimensional point cloud data received from a three-dimensional volumetric image sensor.

In some embodiments, the one or more sensors may include a sensor of a robot. Further, the computing system may obtain the sensor data captured by one or more sensors of the robot. The sensor may capture the sensor data based on movement of the robot along a route through the site. The route may include a set of route waypoints and at least one route edge.

In some embodiments, the sensor data may be captured by a set of sensors from two or more robots. For example, the sensor data may include a first portion (e.g., set) of sensor data captured by one or more first sensors of a first robot (e.g., first sensor data obtained by the first robot) and a second portion (e.g., set) of sensor data captured by one or more second sensors of a second robot (e.g., second sensor data obtained by the second robot). Further, the computing system may merge the first portion of sensor data and the second portion of sensor data to obtain the sensor data.

The computing system may determine route data (e.g., route data associated with the site) based at least in part on the sensor data. The route data may include a set of route waypoints and at least one route edge. The at least one route edge may connect a first route waypoint of the set of route waypoints to a second route waypoint of the set of route waypoints. Further, the at least one route edge may represent a route for the robot through the site.

In some cases, the computing system may automatically perform a loop closure (e.g., automatically perform loop closure generation) based on the satellite-based position data and/or the composite data. For example, the computing system may identify a relationship between a first route waypoint and a second route waypoint based on the satellite-based position data and/or the composite data.

At block 806, the computing system instructs a robot to perform a localization based on the composite data (e.g., the filtered composite data). In some cases, the computing system may obtain an input (e.g., via a user computing device) identifying a waypoint (e.g., within a map) and may instruct the robot to perform the location based on the waypoint (e.g., with respect to the waypoint). Based on performing the localization, the computing system may generate a localization output indicating a position of the robot with respect to the site.

In some cases, the computing system may instruct the robot to perform a localization based on an identified manner of performing localization (e.g., indicating how to compare data, indicating data to filter out prior to performing localization, etc.). For example, the computing system may determine that the sensor data (e.g., the composite data) has a particular data type (e.g., a data type corresponding to a satellite-based position data type or a combination of the satellite-based position data type and an odometry data type) and may determine a manner of performing localization based on data type. All or a portion of the data types may be associated with a different manner of performing localization. For example, the satellite-based position data type may be associated with a first manner of performing localization, the odometry data type may be associated with a second manner of performing localization, and a combination of the satellite-based position data type and the odometry data type may be associated with a third manner of performing localization.

The computing system may instruct the robot to perform a localization using first composite data and second composite data as indicated by a map. The computing system may identify the map that may include one or more route waypoints and one or more route edges that are associated with second composite data (e.g., second satellite-based position data). For example, the computing system may generate a map using first generated composite data based on traversal of the site and may use second generated composite data (e.g., composite data generated subsequently to the first generated composite data) to localize within the site based on the map and the first generated composite data. The computing system may perform the localization by performing point cloud matching, latitude and/or longitude matching, etc.

In some cases, the computing system may generate the map based on performing (e.g., automatically) a loop closure between route waypoints. For example, the computing system may automatically identify one or more route waypoints and one or more route edges and may automatically perform a loop closure between two route waypoints based on composite data (e.g., satellite-based position data). To automatically perform the loop closure, the computing system may identify first satellite-based position data associated with a first route waypoint and second satellite-based position data associated with a second route waypoint and determine a difference between the first satellite-based position data and the second satellite-based position data is less than or matches a first threshold (and an error associated with the satellite-based position sensor is less than or matches a second threshold). Based on determining the difference is less than or matches the first threshold (and the error is less than or matches the second threshold), the computing system can determine the robot can traverse between the first route waypoint and the second route waypoint, the computing system can determine a relationship between the first route waypoint and the second route waypoint, etc. In some cases, the computing system can perform the loop closure using other composite data (e.g., image data) in response to determining the difference is less than or matches the first threshold (and the error is less than or matches the second threshold).

In some cases, the computing system may merge (e.g., automatically) one or more maps. For example, all or a portion of the one or more maps may be associated with satellite-based position data. Based on the satellite-based position data, the computing system may identify all or a portion of the one or more maps that can be merged (e.g., based on all or a portion of the one or more maps being associated with the same satellite-based position data). The computing system may merge all or a portion of the one or more maps and/or store the merged map for use by the robot. In some cases, the computing system may instruct display of the merged map and/or of all or a portion of the one or more maps overlaid together (e.g., based on all or a portion of the one or more maps being associated with the same satellite-based position data) via a user interface.

Based on the map and the composite data (e.g., the satellite-based position data), the computing system may identify one or more relationships between one or more route waypoints of the map (e.g., route edges), one or more relationships between one or more route waypoints and the site, etc. For example, the computing system may automatically register relationships between route waypoints and other route waypoints and/or automatically register relationships between route waypoints and the site (e.g., a map, a satellite view of a site). The computing system may identify the one or more relationships between one or more route waypoints of the map, one or more relationships between one or more route waypoints and the site, etc. based on the composite data and the map using an optimization problem. The optimization problem may include and/or may be based on one or more variables and one or more cost functions. For example, the one or more variables may include one or more locations of one or more waypoints within the map and/or the one or more cost functions may include or may be based on wherein one or more cost functions of the optimization problem are based on one or more of the satellite-based position data, the odometry data, the point cloud data, the ground plane data, the step location data, the fiducial data, the loop closure data, the stair model, height data, texture data, or the user annotation. The computing system may solve the optimization problem to identify one or more solutions to the one or more variables using the cost function.

In some cases, the map may be generated prior to traversal of the site by the robot. For example, a user can provide second satellite-based position data indicating one or more satellite-based positions within a site without navigating the robot through the site. In some cases, the computing system may generate the second composite data using the second satellite-based position data without navigating the robot through the site. The computing system may generate a map that includes the second satellite-based position data and/or the second composite data. Using the map that may be generated without navigating the robot through the site, the robot can localize within the site when navigating a site initially (e.g., without a prior navigation of the site by the robot) using the second satellite-based position data and/or the second composite data as indicated by the map and obtained satellite-based position data (e.g., first satellite-based position data) and/or composite data (e.g., first composite data).

In some cases, to determine an initial position of the robot, the computing system may use fiducial data. For example, the computing system may identify a position of a fiducial in the site with respect to the map and determine a position of the robot based on the position of the fiducial. In some cases, to determine an initial position of the robot, the computing system may instruct the robot to traverse the site, obtain satellite-based position data based on traversal of the site, and determine a position of the robot based on the satellite-based position data.

In some cases, different robots may perform localization within the same site using different data (e.g., different types of data). For example, the different robots may perform localization within the same site using different data based on the sensors associated with the robots. In some cases, the different robots may be associated with the same sensors or the same type of sensors (e.g., lidar sensors, satellite-based position sensors, gyroscopes, etc.). A computing system of a first robot located in the site may obtain, from one or more first sensors associated with the first robot, a first set of sensor data including satellite-based position data and associated with the first robot. A computing system of a second robot located in the site may obtain, from one or more second sensors associated with the second robot, a second set of sensor data associated with the second robot. The one or more first sensors and the one or more second sensors may include one or more different sensors and/or the first set of sensor data and the second set of sensor may have one or more different data types. The computing system of the first robot may instruct the first robot to localize within the site based on the first set of sensor data and the computing system of the second robot may instruct the second robot to localize within the site based on the second set of sensor data.

In some cases, the computing system may instruct the robot to perform a first localization based on a first set of composite data that may not include satellite-based position data and instruct the robot to perform a first action based on the first localization. For example, the computing system may not be connected to a satellite-based position sensor during a first time period and may not obtain satellite-based position data. At a second time period, a satellite-based position sensor may be connected (e.g., via a wireless connection, a wired connection) to the robot (e.g., via a port of the robot). In some cases, the satellite-based position sensor may be a network device. The computing system may determine the connection of the satellite-based position sensor to a port of the one or more ports of the robot. The computing system may obtain a second set of composite data associated with the robot that includes satellite-based position data based on the connection of the satellite-based position sensor to the port. The computing system may instruct the robot to perform a second localization based on the second set of localization data and instruct the robot to perform a second action based on the second localization.

At block 808, the computing system instructs the robot to perform an action. The computing system may instruct the robot to perform an action based on the localization (e.g., the localization output). For example, the action may include moving one or more legs or an arm of the robot, obtaining sensor data from one or more sensors, providing an audio or visual output via an output device of the robot (e.g., a display or speaker of the robot), manipulating or interacting with an entity, object, obstacle, or structure within the site, etc.

In some cases, the computing system may instruct the robot to perform a first localization based on a first set of satellite-based position data using a second set of satellite-based position data associated with a first route waypoint within a map and perform a first action based on the first localization. In some cases, the computing system may instruct the robot to perform a second localization based on a first set of odometry data using a second set of odometry data associated with the first route waypoint and perform a second action based on the first location such that the robot can separately perform localization relative to the same waypoint using different types of data (e.g., satellite-based position data or odometry data).

While reference may be made herein to the computing system instructing the robot (or another system) to perform an act (e.g., perform localization, perform an action, display of a user interface, etc.), it will be understood that the computing system may instruct and/or cause (e.g., control, initiate, coordinate, trigger, etc.) performance of the act (e.g., movement by the robot). For example, the computing system may instruct the robot by providing instructions (e.g., computer-executable instructions) to the robot to perform the act and the robot may execute the instructions and may perform the act based on execution of the instructions.

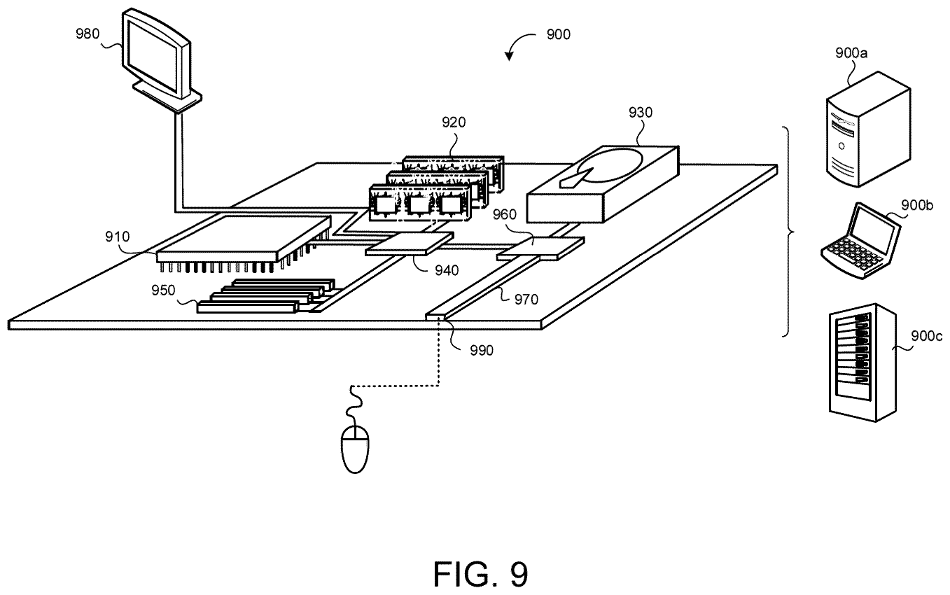

FIG. 9 is a schematic view of an example computing device 900 that may be used to implement the systems and methods described in this document. The computing device 900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 900 includes a processor 910, memory 920, a storage device 930, a high-speed interface/controller 940 connecting to the memory 920 and high-speed expansion ports 950, and a low-speed interface/controller 960 connecting to a low-speed bus 970 and a storage device 930. All or a portion of the processor 910, the memory 920, the storage device 930, the high-speed interface/controller 940, the high-speed expansion ports 950, and the low-speed interface/controller 960 may be interconnected using various busses, and may be mounted on a common motherboard or in other manners as appropriate. The processor 910 can process instructions for execution within the computing device 900, including instructions stored in the memory 920 or on the storage device 930 to display graphical information for a graphical user interface (GUI) on an external input/output device, such as display 980 coupled to high-speed interface/controller 940. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 920 (e.g., non-transitory memory) may store information non-transitorily within the computing device 900. The memory 920 may be a computer-readable medium, a volatile memory unit(s), or non-volatile memory unit(s). The memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random-access memory (DRAM), static random-access memory (SRAM), phase change memory (PCM) as well as disks or tapes.

The storage device 930 is capable of providing mass storage for the computing device 900. In some implementations, the storage device 930 is a computer-readable medium. In various different implementations, the storage device 930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 920, the storage device 930, or memory on processor 910.

The high-speed interface/controller 940 manages bandwidth-intensive operations for the computing device 900, while the low-speed interface/controller 960 manages lower bandwidth-intensive operations. Such allocation of duties is exemplary only. In some implementations, the high-speed interface/controller 940 is coupled to the memory 920, the display 980 (e.g., through a graphics processor or accelerator), and to the high-speed expansion ports 950, which may accept various expansion cards (not shown). In some implementations, the low-speed interface/controller 960 is coupled to the storage device 930 and a low-speed expansion port 990. The low-speed expansion port 990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900a or multiple times in a group of such servers, as a laptop computer 900b, or as part of a rack server system 900c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. A processor can receive instructions and data from a read only memory or a random-access memory or both. The essential elements of a computer may be a processor for performing instructions and one or more memory devices for storing instructions and data. A computer can include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A method comprising:
obtaining, by data processing hardware of a legged robot, satellite-based position data representing a set of positions of the legged robot within a site of the legged robot;
generating, by the data processing hardware, composite data reflecting the satellite-based position data and at least one of odometry data or point cloud data, wherein generating the composite data comprises associating each of the set of positions of the legged robot with at least one of a portion of the odometry data or a portion of the point cloud data;
instructing, by the data processing hardware, the legged robot to perform a localization based on the composite data; and
instructing, by the data processing hardware, the legged robot to perform an action based on the localization.

2. The method of claim 1, wherein generating the composite data comprises merging the satellite-based position data and the at least one of the odometry data or the point cloud data.

3. The method of claim 1, further comprising:
determining one or more values associated with the point cloud data are less than or equal to one or more reliability thresholds, wherein the composite data reflects the satellite-based position data and the odometry data, wherein generating the composite data is based on determining the one or more values are less than or equal to the one or more reliability thresholds.

4. The method of claim 1, wherein obtaining the satellite-based position data comprises obtaining the satellite-based position data from at least one satellite-based position sensor, wherein the at least one satellite-based position sensor is detachable from the legged robot.

5. The method of claim 1, further comprising:
filtering at least a portion of the satellite-based position data from the composite data based on at least one of the odometry data, a number of satellites associated with the satellite-based position data, or an uncertainty associated with the satellite-based position data.

6. The method of claim 1, wherein the satellite-based position data comprises first satellite-based position data, the method further comprising:
identifying a map, wherein the map comprises one or more waypoints and one or more edges, wherein the one or more waypoints are associated with second satellite-based position data, wherein instructing the legged robot to perform the localization is further based on the map.

7. The method of claim 1, wherein the composite data further comprises at least one of ground plane data, step location data, fiducial data, loop closure data, or a user annotation, the method further comprising:
identifying a map comprising one or more waypoints and one or more edges, wherein the one or more waypoints are associated with the composite data, and wherein instructing the legged robot to perform the localization is further based on the map.

8. The method of claim 1, further comprising:
identifying a map comprising one or more waypoints and one or more edges, wherein the one or more waypoints are associated with the composite data, and wherein instructing the legged robot to perform the localization is further based on the map; and
identifying a relationship between a first waypoint of the one or more waypoints and a second waypoint of the one or more waypoints based on the composite data.

9. The method of claim 1, further comprising:
identifying a map comprising one or more waypoints and one or more edges, wherein the one or more waypoints are associated with the composite data, and wherein instructing the legged robot to perform the localization is further based on the map; and
identifying a relationship between the one or more waypoints and the site based on the composite data.

10. The method of claim 1, further comprising:
identifying a map comprising one or more waypoints and one or more edges, wherein the one or more waypoints are associated with composite data, and wherein instructing the legged robot to perform the localization is further based on the map;
identifying a first relationship between a first waypoint of the one or more waypoints and a second waypoint of the one or more waypoints based on the composite data using an optimization problem; and
identifying a second relationship between the one or more waypoints and the site based on the composite data using the optimization problem.

11. The method of claim 1, wherein the composite data further comprises at least one of ground plane data, step location data, fiducial data, loop closure data, or a user annotation, the method further comprising:
identifying a map comprising one or more waypoints and one or more edges, wherein the one or more waypoints are associated with the composite data, and wherein instructing the legged robot to perform the localization is further based on the map;
identifying a first relationship between a first waypoint of the one or more waypoints and a second waypoint of the one or more waypoints using an optimization problem; and
identifying a second relationship between the one or more waypoints and the site using the optimization problem, wherein one or more variables of the optimization problem comprise one or more locations of the one or more waypoints, wherein one or more cost functions of the optimization problem are based on one or more of the satellite-based position data, the odometry data, the point cloud data, the ground plane data, the step location data, the fiducial data, the loop closure data, or the user annotation.

12. The method of claim 1, further comprising:
generating a user interface, wherein the user interface comprises the composite data overlaid on a representation of the site; and
instructing display of the user interface.

13. The method of claim 1, further comprising:
generating a user interface, wherein the user interface comprises the composite data overlaid on a representation of the site;
instructing display of the user interface;
receiving input via the user interface; and
instructing the legged robot to navigate to a location within the site based on the input.

14. The method of claim 1, further comprising:
generating a user interface, wherein the user interface comprises the composite data overlaid on a representation of the site;
instructing display of the user interface;
receiving input via the user interface; and
updating at least one of the composite data or the satellite-based position data based on the input.

15. The method of claim 1, further comprising:
generating a user interface, wherein the user interface comprises the composite data overlaid on a representation of the site; and
updating the user interface in real time to provide a live representation of a position of the legged robot within the site.

16. The method of claim 1, further comprising:
automatically performing loop closure generation based on the satellite-based position data.

17. The method of claim 1, further comprising:
identifying a relationship between at least one of the site or at least a portion of the composite data and a physical coordinate system;
generating a user interface, wherein the user interface indicates the relationship; and
instructing display of the user interface.

18. A system comprising:
data processing hardware; and
memory in communication with the data processing hardware, the memory storing instructions that when executed on the data processing hardware cause the data processing hardware to:
obtain satellite-based position data representing a set of positions of a legged robot within a site of the legged robot;
generate composite data reflecting the satellite-based position data and at least one of odometry data or point cloud data, wherein generating the composite data comprises associating each of the set of positions of the legged robot with at least one of a portion of the odometry data or a portion of the point cloud data;
instruct the legged robot to perform a localization based on the composite data; and
instruct the legged robot to perform an action based on the localization.

19. The system of claim 18, wherein execution of the instructions on the data processing hardware further causes the data processing hardware to:
identify a map comprising one or more waypoints and one or more edges, wherein the one or more waypoints are associated with the composite data, and wherein instructing the legged robot to perform the localization is further based on the map;
identify a first relationship between a first waypoint of the one or more waypoints and a second waypoint of the one or more waypoints based on the composite data using an optimization problem; and
identify a second relationship between the one or more waypoints and the site based on the composite data using the optimization problem, wherein one or more variables of the optimization problem comprise one or more locations of the one or more waypoints.

20. The system of claim 18, wherein the odometry data is based on one or more steps of one or more legs of the legged robot.

21. The system of claim 18, wherein the satellite-based position data comprises first satellite-based position data, wherein execution of the instructions on the data processing hardware further causes the data processing hardware to:
identify a map, wherein the map comprises one or more waypoints and one or more edges, wherein the one or more waypoints are associated with second satellite-based position data, wherein instructing the legged robot to perform the localization is further based on the map, wherein the map is generated prior to the legged robot traversing the site.

22. A robot comprising:
at least two legs;
data processing hardware; and
memory in communication with the data processing hardware, the memory storing instructions that when executed on the data processing hardware cause the data processing hardware to:
obtain satellite-based position data representing a set of positions of the robot within a site of the robot;
generate composite data reflecting the satellite-based position data and at least one of odometry data or point cloud data, wherein generating the composite data comprises associating each of the set of positions of the robot with at least one of a portion of the odometry data or a portion of the point cloud data;
instruct the robot to perform a localization based on the composite data; and
instruct the robot to perform an action based on the localization.

23. The robot of claim 22, wherein execution of the instructions on the data processing hardware further causes the data processing hardware to:
obtain the satellite-based position data from at least one satellite-based position sensor, wherein the at least one satellite-based position sensor is connected to the robot via a port.

24. The robot of claim 22, wherein the odometry data is based on one or more steps of one or more legs of the legged robot.

25. The robot of claim 22, wherein execution of the instructions on the data processing hardware further causes the data processing hardware to:
filter at least a portion of the satellite-based position data from the composite data based on the odometry data.
